(19) United States
(12) Patent Application Publication
(10) Pub. No.: US 2025/0043147 A1
(43) Pub. Date: Feb. 6, 2025

(54) HYDROPHOBIC AND OLEOPHOBIC COATINGS, METHODS OF MAKING SAME AND USES OF SAME

(71) Applicant: CORNELL UNIVERSITY, Ithaca, NY (US)

(72) Inventors: Genggeng Qi, Ithaca, NY (US); Emmanuel Giannelis, Ithaca, NY (US)

(21) Appl. No.: 18/557,888

(22) PCT Filed: May 2, 2022
(86) PCT No.: PCT/US2022/027305

§ 371 Date: Oct. 27, 2023

Related U.S. Application Data
(60) Provisional application No. 63/182,172, filed on Apr. 30, 2021.

(51) Int. Cl. C09D 183/06; C09D 133/14; D06M 15/273; D06M 101/06; D06M 101/10; D06M 101/32

(52) U.S. Cl. CPC C09D 183/06; C09D 133/14; D06M 15/273; D06M 2101/06; D06M 2101/10; D06M 2101/32; D06M 2200/11; D06M 2200/12

(57) ABSTRACT

Hydrophobic and oleophobic coatings, methods of making same, and uses of same. A coating can comprise one or more oleophobic and/or hydrophobic layer(s) disposed on a substrate, e.g., a fabric or the like. A layer comprises polymeric particles, which may be at least partially coalesced and/or crosslinked, comprising (co) polymer chains comprising silicon-containing pendant groups. A method of making a layer comprises: coating a substrate with an aqueous dispersion of the polymeric particles; and, optionally, curing the layer, e.g., to coalesce and/or crosslink the polymeric particles. A method of making the aqueous dispersion may comprise: forming a reaction mixture comprising one or more monomers comprising silicon-containing pendant groups; optionally, one or more comonomers; surfactant, and water. Coatings of the present disclosure have use in aerospace applications, automotive applications, building and construction, food processing, and electronics, or the like.

### CROSS-REFERENCE TO RELATED APPLICATIONS

This application claims the benefit of U.S. Provisional Patent Application No. 63/182,172, filed Apr. 30, 2021, the contents of the above-identified application are hereby fully incorporated herein by reference in their entirety.

### BACKGROUND OF THE DISCLOSURE

Hydrophobic and oleophobic coatings find extensive applications in numerous fields, such as textile finishing, electronics protection, antifouling, deicing, paints for automotives, appliances, and buildings, household products, and personal care products. The active ingredients of these coatings contributing to water and/or oil repellency are typically low surface energy materials, such as waxes, silicones, and fluorocarbons.

U.S. Pat. No. 7,501,471B2 describes a waterborne hydrophobic coating formulation comprising a blend of poly(vinyl acetate-ethylene) and paraffin wax emulsions. U.S. Pat. No. 6,169,066B1 discloses a waterborne hydrophobic cleaning coating composition with combined silicone resins. U.S. Pat. No. 8,900,673B2 discloses a durable water-repellent textile coating based on polydimethylsiloxane containing polyurethane. U.S. Pat. No. 8,354,480B2 discloses aqueous silicone emulsions containing hydroxyl and amino functional polysiloxanes for water repellency applications. U.S. Pat. No. 6,140,414A discloses a silicone-based aqueous emulsion composition with good flexibility and flame retardancy. U.S. Pat. No. US20150275437A1 discloses an organopolysiloxane water repellent emulsion coating containing amino and anhydride organoalkoxysilanes. U.S. Pat. No. 7,544,734B2 describes silicone emulsion compositions useful for water repellent applications. U.S. Pat. No. US20060130990A1 provides a reactive silicone emulsion composition for softening tissue paper and other cellulosics.

While previous hydrophobic coatings based on long chain alkyl compounds and conventional silicones exhibit water repellence, they can fail to repel oils due to much lower surface energies of oils (typically less than 38 millinewton per meter (mN/m)) than that of water (˜73 mN/m). As a result, current oleophobic coatings are based on fluorinated compounds with extremely low surface energy. U.S. Pat. No. 9,382,441B2 discloses a hydrophobic and oleophobic coating by a combination of polyacrylic resin and fluorosiloxane. U.S. Pat. No. US20080214075A1 describes textile finishings with water and oil repellency and self-cleaning properties, where fluorocarbon prepolymers and fluorocarbon modified nanoparticles are used. U.S. Pat. No. 9,896,549B2 discloses the fabrication of hydrophobic and oleophobic coatings by encapsulation of fluorocarbons in the porous coating layer. U.S. Pat. No. 4,617,057A discloses an oil and water repellent coating composition comprising perfluorinated compounds and a base resin. U.S. Pat. No. 10,240,049B2 provides a superhydrophobic and oleophobic waterborne polyurethane coating composition comprising fluoroalkyl or perfluoroalkyl functionalized particles. U.S. Pat. No. US20160289810A1 describes a durable hydrophobic, oleophobic and anti-icing coating containing perfluoroalkyl modified particles.

The textile industry is under significant pressure to remove all hazardous chemicals from their products and supply chain. High on that list of chemicals are fluorine-containing compounds. Because of their resistance to both water and oil, per- and polyfluorinated substances are extremely attractive in a number of industrial applications and consumer products such as carpeting, apparels, and upholstery. Polyfluorinated compounds are resistant to degradation and persist in the environment. They bioaccumulate and some have been linked to adverse health effects at least in laboratory animals.

Finding replacements for fluorine-based compounds while maintaining the same level of performance and durability is not trivial. Oil repellent coatings are useful for several consumer products and industrial applications such as antiwetting and self-cleaning. While there are many examples of superhydrophobic coatings, limited progress has been made towards highly oleophobic coatings. Many superhydrophobic coatings turn out to be oleophilic. In addition, in contrast to the superhydrophobic state, oleophobicity can be different depending on the type of oils. A superoleophobic surface (contact angle >150°) to a certain oil may be oleophilic to another with lower surface tension.

A challenge in engineering oleophobic coatings stems from a fundamental limitation in materials. As typical surface tensions of hydrocarbon oils are in the range of 20-36 mN/m, the surface tension of a smooth oil repellent substrate, according to the Young's equation, must be less than 20 mN/m². Specifically, the surface energy of olive oil is ˜32 mN/m, and depending on their type, the surface energy for vegetable oils is typically in the low 30s mN/m. Mineral oil, which is the first oil used in the AATCC® oleophobicity standard testing (Grade 1), has a surface energy of 31.5 mN/m. The requirement for low surface energy suggests that most commonly used materials are not intrinsically oleophobic. Only a few fluorinated materials can meet this prerequisite for oleophobicity. Indeed, so-called superoleophobic coatings developed to date use fluorinated compounds with abundant —CF₂- and —CF₃ groups, such as PTFE, perfluorosilanes and perfluoropolymers. Considering the material's limitation of intrinsic surface tension, essentially all previously developed highly-oleophobic coatings are based on low surface energy fluorinated materials.

The most extensively used fluorinated compounds, perfluorooctanoic acid (PFOA), perfluorooctane sulfonate (PFOS) and their derivatives, are persistent and bioaccumulating in the environment. They have been linked to many adverse health effects such as thyroid dysfunction, immune disorders, and liver diseases. Their replacements, GenX (mainly hexafluoropropylene oxide dimer acid and its ammonium salt) and perfluorobutane sulfonic acid (PFBS), are also found to be highly toxic. U.S. Pat. No. US20200079974A1 describes fluorine-free oleophobic coating compositions based on specially structured polydimethylsiloxanes and application of the coating via solvent-borne systems.

### SUMMARY OF THE DISCLOSURE

In an aspect, the present disclosure provides methods of making coatings comprising one or more oleophobic and/or hydrophobic layer(s) (e.g., of the present disclosure). In various examples, a method is used to make one or more oleophobic and/or hydrophobic layer(s) of the present disclosure. In various examples, a method of forming an oleophobic and/or hydrophobic layer comprises: coating a portion of, substantially all of, or all of one or more of the exterior surface(s) of the substrate with an aqueous dispersion comprising a plurality of polymeric particles (e.g., of the present invention). In various examples, each individual polymeric particle comprises one or more oleophobic and/or hydrophobic polymer(s) and/or one or more oleophobic and/or hydrophobic copolymer(s). In various examples, the polymer(s) and/or the copolymer(s) comprise(s) one or more pendant group(s) comprising the following structure:

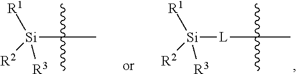

where R¹, R², and R³ are independently at each occurrence chosen from alkyl groups, alkoxy groups, aryl groups, hydroxyl groups, halogen groups, substituted derivatives and analogs thereof, and —O—SiR′₃ groups, where R′ is independently at each occurrence chosen from alkyl groups, aryl groups, and substituted derivates and analogs thereof, where, for at least one or more of the pendant group(s) of each of the polymer(s) and/or each of the copolymer(s), at least one of R¹, R², and R³ is independently at each occurrence chosen from the —O—SiR′₃ groups, where L is a linking group, and where the pendant group(s) is/are independently at each occurrence covalently bonded to the polymer(s) and/or the copolymer(s) via one or more backbone(s) and/or one or more substituent group(s) of the polymer(s) and/or the copolymer(s); and where the oleophobic and/or hydrophobic layer is formed on a portion of, substantially all of, or all of one or more of the exterior surface(s) of the substrate; and, optionally, curing the oleophobic and/or hydrophobic layer. In various examples, at least a portion of, substantially all of, or all of the polymeric particles are composite polymeric particles (e.g., of the present disclosure). In various examples, the polymeric particle(s), independently, has/have a size of from about 3 nm to about 1000 microns.

In various examples, the backbone(s) is/are independently at each occurrence chosen from polydimethylsiloxane backbone(s), hydrocarbon polymer backbone(s), poly(vinyl chloride) backbone(s), polytetrafluoroethylene backbone(s), polyacrylate backbone(s), polymethacrylate backbone(s), polystyrene backbone(s), polyarylene backbone(s), polyether backbone(s), poly(vinyl ester) backbone(s), poly(allyl ether) backbone(s), polyester backbone(s), polyurethane backbone(s), polyurea backbone(s), polyamide backbone(s), polyimide backbone(s), polysulfone backbone(s), polycarbonate backbone(s), and copolymer(s) thereof. In various examples, the pendant group(s) comprise(s) tris(trialkylsiloxy)silyl group(s), alkoxysilane group(s), or any combination thereof, and the alkyl group(s) is/are independently at each occurrence chosen from C₁ to C₄₀ alkyl group(s). In various examples, the pendant group(s), independently, comprise(s) the following structure:

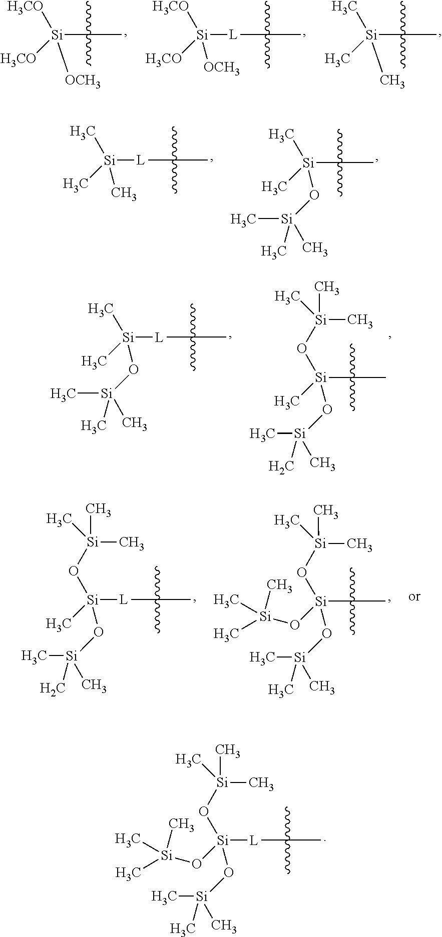

In various examples, the coating comprises spray coating, dip coating, floating knife coating, direct roll coating, padding, calendar coating, foam coating, spin coating, flow coating, or any combination thereof. In various examples, a method further comprises, prior to the coating, forming the aqueous dispersion comprising the plurality of polymeric particles. In various examples, the forming comprises: forming a reaction mixture comprising: one or more monomer(s) comprising the pendant group(s), wherein the pendant group(s) is/are first pendant group(s); optionally, one or more comonomer(s); one or more surfactant(s); optionally, one or more initiator(s); optionally, one or more crosslinker(s); optionally, a plurality of nanoparticles; optionally, one or more non-aqueous solvent(s); and water; and holding the reaction mixture at a time and at a temperature such that the aqueous dispersion comprising the plurality of polymeric particles is formed.

In various examples, the monomer(s) comprise(s) tris(trialkylsiloxy)silyl vinyl monomer(s), alkoxysilane vinyl monomer(s), or any combination thereof, and wherein the alkyl group(s) is/are independently at each occurrence chosen from C₁ to C₄₀ alkyl group(s). In various examples, the monomer(s) comprise(s) a molar ratio of the (trialkylsiloxy)silyl monomer(s) to the alkoxysilane monomer(s) of about 1 or greater. In various examples, the reaction mixture comprises from about 40 molar percent (mol %) to about 100 mol % of the monomer(s) based on the total moles of the monomer(s) and the comonomer(s).

In various examples, the surfactant(s) is/are chosen from anionic surfactant(s), cationic surfactant(s), zwitterionic surfactant(s), nonionic surfactant(s), and any combination thereof. In various examples, the reaction mixture comprises from about 0.01 weight percent (wt. %) to about 40 wt. % of the surfactant(s). In various examples, the initiator(s) is/are chosen from thermal initiator(s), photoinitiator(s), redox initiator(s), reversible-deactivation radical initiator(s), anionic initiator(s), cationic initiator(s), Ziegler-Natta catalysts, and any combination thereof. In various examples, the reaction mixture comprises from about 0.01 weight percent (wt. %) to about 20 wt. % of the initiator(s). In various examples, the method comprises an emulsion polymerization, a miniemulsion polymerization, a microemulsion polymerization, a dispersion polymerization, an interfacial polymerization, or a suspension polymerization. In various examples, the method further comprises post-polymerization functionalizing the polymer(s) and/or the copolymer(s) to form one or more of the pendant group(s), wherein the pendant group(s) is/are second pendant group(s).

In various examples, the method further comprises, prior to the coating, pretreating the substrate. In various examples, the pretreating comprises coating the substrate with a primer layer comprising one or more functional group(s) which increase(s) the crosslinking density between the substrate and the oleophobic and/or hydrophobic layer. In various examples, the primer layer comprises a sol of one or more non-metal oxide(s), a sol of one or more metal oxide(s), or any combination thereof. In various examples, the substrate comprises a plurality of nanoparticles disposed in or upon the primer layer. In various examples, the oleophobic and/or hydrophobic layer further comprises a plurality of nanoparticles.

In various examples, the curing comprises maintaining the coating at a temperature of from about −30 degrees Celsius (° C.) to about 200° C., and/or for a time of from about 1 second to about 2 weeks. In various examples, the method further comprising adding additional surface roughness to the oleophobic and/or hydrophobic layer. In various examples, the coating and, optionally, the curing is/are repeated from 1 to 100 times. In various examples, the thickness of the oleophobic and/or hydrophobic layer is from about 2 nm to about 1000 microns.

In an aspect, the present disclosure provides coatings comprising one or more oleophobic and/or hydrophobic layer(s). In various examples, a method of the present disclosure is used to make the oleophobic and/or hydrophobic layer(s). In various examples, the oleophobic and/or hydrophobic layer(s) is/are disposed on a portion of, substantially all of, or all of one or more exterior surface(s) of a substrate. In various examples, the oleophobic and/or hydrophobic layer(s) comprise(s) a plurality of polymeric particles (e.g., polymeric particles of the present disclosure). In various examples, a portion of, substantially all of, or all of the polymeric particle(s) is/are at least partially coalesced. In various examples, the polymeric particle(s), independently, carr(ies) one or more surface charge(s) chosen from one or more positive charge(s), one or more negative charge(s), one or more zwitterionic charge(s), and any combination thereof. In various examples, the polymer(s) and/or the copolymer(s) comprise(s) a molecular weight (M_{w} and/or Mₙ) of from about 300 g/mol to about 1,000,000 g/mol, and/or wherein the polymer(s) and/or the copolymer(s), independently, has/have from about 3 repeat units to about 50,000 repeat units. In various examples, the pendant group(s) comprise(s) tris(trialkylsiloxy)silyl group(s), alkoxysilane group(s), or any combination thereof, and wherein the alkyl group(s) is/are independently at each occurrence chosen from C₁ to C₄₀ alkyl group(s). In various examples, the pendant group(s) comprise(s) a molar ratio of (trialkylsiloxy)silyl group(s) to alkoxysilane group(s) of about 1 or greater. In various examples, the from about 10% to about 100% of the repeat units of the backbone(s) comprise the pendant group(s).

In various examples, the substrate is porous or nonporous. In various examples, the substrate is a fabric, a fiber, a filament, a membrane, glass, ceramic, carbon, metal or metal alloy, wood, polymer, plastic, paper, concrete, brick, leather, or rubber. In various examples, the fabric comprises cotton, polyethylene terephthalate (PET), nylon, polyester, spandex, silk, wool, viscose, cellulose fiber, acrylic, polypropylene, leather, or any combination thereof. In various examples, the substrate is fluorine-free, and/or wherein the oleophobic and/or hydrophobic layer is fluorine-free. In various examples, the substrate comprises a plurality of nanoparticles.

In various examples, the oleophobic and/or hydrophobic layer comprises a plurality of nanoparticles. In various examples, the oleophobic and/or hydrophobic layer comprises from about 0.1 weight percent (wt. %) to about 98 wt. % of the plurality of nanoparticles. In various examples, at least one of the polymer(s) and/or at least one of the copolymer(s) comprise(s) one or more crosslinkable group(s). In various examples, the oleophobic and/or hydrophobic layer comprises one or more crosslinked group(s). In various examples, the oleophobic and/or hydrophobic layer comprises one or more intramolecular and/or intermolecular crosslinked groups(s) and/or one or more crosslinked group(s) between the substrate and at least one of the polymer(s) and/or at least one of the copolymer(s). In various examples, the crosslinked group(s) comprise one or more crosslinked pending polysiloxane group(s), and wherein the polysiloxane group(s) is/are chosen from linear polysiloxane group(s), branched polysiloxane group(s), and any combination thereof.

In various examples, the oleophobic and/or hydrophobic layer comprises additional surface roughness. In various examples, the oleophobic and/or hydrophobic layer comprises from 1 to 100 same or different oleophobic and/or hydrophobic layer(s). In various examples, the thickness of the oleophobic and/or hydrophobic layer is from about 2 nm to about 1000 microns. In various examples, the oleophobic and/or hydrophobic layer has a surface tension of 22 millijoules per square meter (mJ/m²) or less. In various examples, the oleophobic and/or hydrophobic layer comprises and/or exhibits one or more or all of the following: a passing score for the AATCC® Test Method 118-2013 for one or more oil(s); or a contact angle with an oil grade 1 of greater than 90°; or a contact angle with an oil grade 3 of greater than 70°.

In an aspect, the present disclosure provides articles of manufacture. In various examples, an article of manufacture comprises one or more oleophobic and/or hydrophobic layer(s) of the present disclosure and/or made by a method of the present disclosure. In various examples, the article of manufacture is a textile, an article of clothing, food packaging, eye glasses, a display, a scanner, an airplane coating, a sporting good, a building material, a window, a windshield, a corrosion resistant coating, an anti-ice coating, a condenser, a container, a toilet, or a light. In various examples, the substrate is a fabric.

### BRIEF DESCRIPTION OF THE FIGURES

For a fuller understanding of the nature and objects of the disclosure, reference should be made to the following detailed description taken in conjunction with the accompanying figures.

FIGS. 1A-1B show an oil resistance comparison of a representative cotton fabric (FIG. 1A) without and (FIG. 1B) with a cationic waterborne fluorine-free oleophobic coating. Test oil: mineral oil.

FIGS. 2A-2C show images of (FIG. 2A) a representative cotton fabric coated with a cationic waterborne fluorine-free oleophobic coating, (FIG. 2B) an oil resistance comparison of a representative cotton fabric (left) without and (right) with a cationic waterborne fluorine-free oleophobic coating, test oil: mineral oil, and (FIG. 2C) an oil resistance comparison of a representative wool fabric with a cationic waterborne fluorine-free oleophobic coating, test oil: vegetable oil.

FIGS. 3A-3C show images of a sessile droplet on (FIG. 3A) cotton, (FIG. 3B) wool, and (FIG. 3C) polyester substrates coated with a cationic waterborne fluorine-free oleophobic coating, test oil: vegetable oil.

FIG. 4 shows a scanning electron microscope (SEM) image of a representative coating of cationic latex particles of a cationic waterborne fluorine-free oleophobic coating on a cotton substrate. Scale bar=1 micron (μm).

FIG. 5A-5B show SEM images of (FIG. 5A) pristine cotton fabric, scale bar=200 nm and (FIG. 5B) cotton fabric coated with the cationic fluorine-free oleophobic coating, scale bar=500 nm. The thickness of the coating is estimated to be less than 200 nm from the SEM images.

FIGS. 6A-6C show (FIG. 6A) an SEM image and (FIGS. 6B-6C) an energy dispersive X-ray (EDX) mapping analysis (FIG. 6B=carbon (C); FIG. 6C=silicon (Si)) of a representative cotton fabric coated with a cationic waterborne fluorine-free oleophobic coating. Scale bars=10 micron (μm).

FIG. 7 shows EDX spectra of (top) a cationic waterborne fluorine-free oleophobic coated cotton fabric and (bottom) a pristine cotton fabric, confirming that the cationic waterborne fluorine-free oleophobic coating is fluorine-free.

### DETAILED DESCRIPTION OF THE DISCLOSURE

Although subject matter of the present disclosure is described in terms of certain embodiments and examples, other embodiments and examples, including embodiments and examples that do not provide all of the benefits and features set forth herein, are also within the scope of this disclosure. For example, various structural, logical, and process step changes may be made without departing from the scope of the disclosure.

As used herein, unless otherwise indicated, “about”, “substantially”, or “the like”, when used in connection with a measurable variable (such as, for example, a parameter, an amount, a temporal duration, or the like) or a list of alternatives, is meant to encompass variations of and from the specified value including, but not limited to, those within experimental error (which can be determined by, e.g., a given data set, an art accepted standard, etc. and/or with, e.g., a given confidence interval (e.g. 90%, 95%, or more confidence interval from the mean), such as, for example, variations of +/−10% or less, +/−5% or less, +/−1% or less, and +/−0.1% or less of and from the specified value), insofar such variations in a variable and/or variations in the alternatives are appropriate to perform in the instant disclosure. As used herein, the term “about” may mean that the amount or value in question is the exact value or a value that provides equivalent results or effects as recited in the claims or taught herein. That is, it is understood that amounts, sizes, compositions, parameters, and other quantities and characteristics are not and need not be exact, but may be approximate and/or larger or smaller, as desired, reflecting tolerances, conversion factors, rounding off, measurement error, or the like, or other factors known to those of skill in the art such that equivalent results or effects are obtained. In general, an amount, size, composition, parameter, or other quantity or characteristic, or alternative is “about” or “the like,” whether or not expressly stated to be such. It is understood that where “about,” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5%, but also, unless otherwise stated, include individual values (e.g., 1%, 2%, 3%, and 4%) and the sub-ranges (e.g., 0.5% to 1.1%; 0.5% to 2.4%; 0.5% to 3.2%, and 0.5% to 4.4%, and other possible sub-ranges) within the indicated range. It is also understood (as presented above) that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent radicals and multivalent radicals, such as, for example, divalent radicals, trivalent radicals, and the like). In certain examples, a group is a moiety (e.g., a part (substructure) or functional group of a molecule). Illustrative examples of groups include:

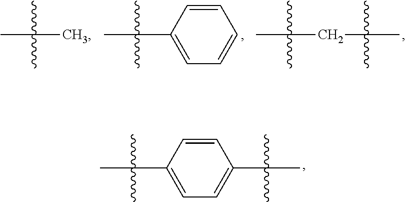

and the like.

As used herein, unless otherwise indicated, the term “alkyl group” refers to branched or unbranched hydrocarbon groups that are saturated (e.g., only single bonds between carbon atoms). In various examples, an alkyl group is a C₁ to C₄₀ (e.g., C₁ to C₃₀, C₁ to C₁₂ C₁ to C₁₀, or C₁ to C₅), including all integer numbers of carbons and ranges of numbers of carbons therebetween, alkyl group. In various examples, an alkyl group is a cyclic alkyl group. Examples of alkyl groups include, but are not limited to, methyl groups, ethyl groups, propyl groups, butyl groups, isopropyl groups, tert-butyl groups, and the like. In various examples, an alkyl group is unsubstituted or substituted with one or more substituent(s). Examples of substituents include, but are not limited to, various substituents such as, for example, halide groups (—F, —Cl, —Br, and —I), aliphatic groups (e.g., additional alkyl groups, alkenyl groups, alkynyl groups, and the like), halogenated aliphatic groups (e.g., trifluoromethyl group and the like), cycloaliphatic groups, aryl groups, halogenated aryl groups, alkoxide groups, amine groups, nitro groups, carboxylate groups, carboxylic acid groups, ether groups, hydroxyl groups, silyl ether groups, isocyanate groups, and the like, and any combination thereof.

As used herein, unless otherwise indicated, the term “alkenyl group” refers to branched or unbranched hydrocarbon groups comprising one or more C—C double bond(s). Examples of alkenyl groups include, but are not limited to, an ethenyl (vinyl) group, 1-propenyl groups, 2-propenyl (allyl) groups, 1-, 2-, and 3-butenyl groups, isopropenyl groups, and the like. In various examples, an alkenyl group is a C₂ to C₂₀ alkylenyl group, including all integer numbers of carbons and ranges of numbers of carbons therebetween (e.g., a C₂, C₃, C₄, C₅, C₆, 20 C₇, C₈, C₉, C₁₀, C₁₁, C₁₂. C₁₃, C₁₄, C₁₅, C₁₆, C₁₇, C₁₈, C₁₉, or C₂₀ alkenyl group). In various examples, an alkenyl group is unsubstituted or substituted with one or more substituent(s). Examples of substituents include, but are not limited to, various substituents such as, for example, halide groups (—F, —Cl, —Br, and —I), aliphatic groups (e.g., alkyl groups, additional alkenyl groups, alkynyl groups, and the like), halogenated aliphatic groups (e.g., trifluoromethyl group and the like), cycloaliphatic groups, additional aryl groups, halogenated aryl groups, alkoxide groups, amine groups, nitro groups, carboxylate groups, carboxylic acid groups, ether groups, hydroxyl groups, silyl ether groups, isocyanate groups, and the like, and any combination thereof.

As used herein, unless otherwise indicated, the term “alkynyl group” refers to branched or unbranched hydrocarbon groups comprising one or more C—C triple bond(s). Examples of alkynyl groups include, but are not limited to ethyne groups, 1- and 2-propyne groups, 1-, 2-, and 3-butyne groups, and the like. In various examples, an alkynyl group is a C₂ to C₂₀ alkynyl group, including all integer numbers of carbons and ranges of numbers of carbons therebetween (e.g., a C₂, C₃, C₄, C₅, C₆, 20 C₇, C₈, C₉, C₁₀, C₁₁, C₁₂. C₁₃, C₁₄, C₁₅, C₁₆, C₁₇, C₁₈, C₁₉, or C₂₀ alkynyl group). In various examples, an alkynyl group is unsubstituted or substituted with one or more substituent(s). Examples of substituents include, but are not limited to, various substituents such as, for example, halide groups (—F, —Cl, —Br, and —I), aliphatic groups (e.g., alkyl groups, alkenyl groups, additional alkynyl groups, and the like), halogenated aliphatic groups (e.g., trifluoromethyl group and the like), cycloaliphatic groups, aryl groups, halogenated aryl groups, alkoxide groups, amine groups, nitro groups, carboxylate groups, carboxylic acid groups, ether groups, hydroxyl groups, silyl ether groups, isocyanate groups, and the like, and any combination thereof.

As used herein, unless otherwise indicated, the term “aryl group” refers to C₅ to C₃₀ aromatic or partially aromatic carbocyclic groups, including all integer numbers of carbons and ranges of numbers of carbons therebetween (e.g., C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, and C₃₀). In various examples, an aryl group is also referred to as an aromatic group. In various examples, aryl groups comprise polyaryl groups such as, for example, fused ring groups, biaryl groups, or a combination thereof. In various examples, the aryl group is unsubstituted or substituted with one or more substituent(s). Examples of substituents include, but are not limited to, various substituents such as, for example, halide groups (—F, —Cl, —Br, and —I), aliphatic groups (e.g., alkyl groups, alkenyl groups, alkynyl groups, and the like), halogenated aliphatic groups (e.g., trifluoromethyl group and the like), cycloaliphatic groups, additional aryl groups, halogenated aryl groups, alkoxide groups, amine groups, nitro groups, carboxylate groups, carboxylic acid groups, ether groups, hydroxyl groups, silyl ether groups, isocyanate groups, and the like, and any combination thereof. In various examples, aryl groups contain one or more hetero atom(s), such as, for example, oxygen, nitrogen (e.g., pyridinyl groups and the like), sulfur, and the like, and any combination thereof. Examples of aryl groups include, but are not limited to, phenyl groups, biaryl groups (e.g., biphenyl groups and the like), fused ring groups (e.g., naphthyl groups and the like), hydroxybenzyl groups, tolyl groups, xylyl groups, furanyl groups, benzofuranyl groups, indolyl groups, imidazolyl groups, benzimidazolyl groups, pyridinyl groups, and the like.

As used herein, unless otherwise indicated, the term “analog” refers to a compound or group that can be envisioned to arise from another compound or group, respectively, if one atom or group of atoms, functional groups, or substructures is replaced with another atom or group of atoms, functional groups, or substructures.

As used herein, unless otherwise indicated, the term “derivative” refers to a compound or group that is envisioned to or is derived from a similar compound or group, respectively, by a chemical reaction, where the compound or group is modified or partially substituted such that at least one structural feature of the original compound or group is retained.

The present disclosure provides layers disposed on a portion of or all of a surface or surfaces of a substrate. The present disclosure also provides methods of making layers of the present disclosure and uses of the layers.

The present disclosure provides, inter alia, methods of making layers (e.g., oleophobic and/or hydrophobic layers). In various examples, methods combine one or more low surface energy material(s) with an engineered surface roughness. Non-limiting methods of controlling surface roughness are described herein. The surface roughness can be engineered, in various examples, by exploiting the molecular structure of any polymers and/or any copolymers within the layer, the particle size and/or particle size dispersity of any particles within the layer, incorporation of organic and/or inorganic additives into the layer, by stamping the layer, or the like, or any combination thereof. Examples of molecular roughness include, but are not limited to, use of branching or rigid segments in any polymers and/or any copolymers in the layer, self-assembly of any polymers and/or copolymers in the layer, microphase separation of any polymer blends in the layer, emulsion polymerization parameters for the synthesis of any polymeric particles (e.g., colloidal polymeric particles or the like) in the layer, by incorporation of organic and/or inorganic nanoparticle additives into the layer, or the like, and any combination thereof.

In an aspect, the present disclosure provides layers. In various examples, a layers are a molecularly rough layer or oleophobic and/or hydrophobic layer or both. In various examples, a layer is disposed on a portion of, substantially all of, or all of one or more or all surface(s) of a substrate. In various examples, a layer is made by a method of the present disclosure. Non-limiting examples of layers are described herein.

In various examples, a layer (e.g., a molecularly rough layer and/or an oleophobic and/or hydrophobic layer) comprises a plurality of polymeric particles (e.g., polymeric particles of the present disclosure) (e.g., polymeric microparticles, polymeric nanoparticles, or the like, or any combination thereof) comprising one or more polymer(s) and/or one or more copolymer(s) (e.g., polymer(s) and/or copolymer(s) of the present disclosure). In various examples, the polymeric particle(s) comprise(s) one or more oleophobic and/or hydrophobic polymer(s) and/or one or more oleophobic and/or hydrophobic copolymer(s).

In various examples, polymer(s) and/or copolymer(s) comprise(s) one or more backbone group(s), one or more pendant group(s), and optionally, one or more crosslinkable group(s) (e.g., crosslinkable backbone group(s), crosslinkable pendant group(s), or the like, or any combination thereof) (e.g., crosslinkable pendant alkoxysilane group(s)), or the like, or any combination thereof). In various examples, polymer(s) and/or copolymer(s) comprising pendant (alkylsiloxy)silyl group(s) and, optionally, pendant alkoxysilane group(s) is/are referred to herein as polysiloxane resin(s) (which may be referred to herein as PDMS resin(s)), which comprise(s) pendant polysiloxane group(s) (which may be referred to herein as PDMS group(s)). In various examples, individual pendant polysiloxane group(s) is/are linear, branched, or any combination thereof.

In various examples, a polymeric particle further comprises: one or more surfactant(s); one or more initiator(s); optionally, one or more crosslinker(s) (e.g., each comprising two or more crosslinkable groups); optionally, one or more nanoparticle(s), (e.g., unmodified nanoparticle(s), modified nanoparticle(s), or any combination thereof) (e.g., silica nanoparticle(s) or the like); or any combination thereof. In various examples, at least a portion of, substantially all of, or all of the polymeric particles are composite polymeric particles (e.g., composite polymer microparticles, composite polymer nanoparticles, or the like, or any combination thereof), where each composite polymeric particle comprises a core-shell structure, the core comprising one or more nanoparticle(s) (e.g., unmodified nanoparticle(s), modified nanoparticle(s), or any combination thereof) (e.g., silica nanoparticle(s) or the like); and the shell comprising one or more or all polymer(s) and/or one or more or all copolymer(s). Non-limiting examples of polymeric particles are described herein.

In various examples, a layer is hydrophobic and/or oleophobic. As used herein, unless otherwise indicated, “oleophobicity” refers to the physical property possessed by a material that is characterized by the material's lack of an affinity for oil. In various examples, an “oleophobic” material exhibits a lack of penetration by oil, a lack of adhesion to oil, repellency of oil, or any combination thereof. Non-limiting examples of oleophobic and/or hydrophobic layer(s) are described herein. In various examples, oleophobicity, or oil repellency of the layer, is evaluated by AATCC® Test Method 118-2013. In various examples, an oleophobic and/or hydrophobic layer passes AATCC® Test Method 118-2013 for one or more oil(s) (e.g., one or more oil(s) set out in AATCC® Test Method 118-2013 or the like) (e.g., corn oil, vegetable oil, mineral oil (grade 1 defined in AATCC® Test Method 118-2013), or the like, or any combination thereof). In various examples, the AATCC® Test Method 118-2013 measurement is carried out using a flat, non-porous substrate.

In various examples, oleophobicity, or oil repellency of the layer, is evaluated by contact angle. In various examples, a contact angle of an oleophobic layer is determined using a vegetable oil (e.g., corn oil or the like), a mineral oil, or the like, as a test fluid according to a method disclosed herein. In various examples, an oleophobic and/or hydrophobic layer exhibits a contact angle with a vegetable oil of greater than 90°, an oil grade 1 of greater than 90°, and/or a contact angle with an oil grade 3 of greater than 70°. In various examples, a contact angle can be measured against a test liquid using a goniometer (e.g., a Biolin Scientific Optical Tensiometer with OneAttension software, or the like) or the like. In a typical contact angle measurement, a droplet of a test liquid, e.g. mineral oil, is placed on a sample and the image of the sessile drop at the points of intersection between the drop contour and the projection of the surface is used to calculate the contact angle (which may be carried out by the software). In various examples, the contact angle measurement is carried out using a flat, non-porous substrate.

The contact angle values can also be used to calculate the surface free energy (which may also be referred to herein as surface tension) of the coating surface using Owens-Wendt model. (See, e.g., Owens, D. K.; Wendt, R. C., Estimation of the Surface Free Energy of Polymers. J. Appl. Polym. Sci. 1969, 13, 1741-1747). Wetting behavior of a surface is categorized into four types based on its water contact angle: (i) superhydrophilic (0°<θ<10°), (ii) hydrophilic (10°<θ<90°), (iii) hydrophobic (90°<θ<150°), and (iv) superhydrophobic (150°<θ<180°). (See, e.g., Das, S.; Kumar, S.; Samal, S. K.; Mohanty, S.; Nayak, S. K., A Review on Superhydrophobic Polymer Nanocoatings: Recent Development and Applications. Ind. Eng. Chem. Res. 2018, 57, 2727-2745). In various examples, a layer has a surface free energy (e.g., a surface tension) of less than or equal to 22 mJ/m² (e.g., less than 22 mJ/m²). In various examples, a surface free energy of a layer is less than 22, 21, 20, 19, or 18 mJ/m². In various examples, a layer has a surface free energy of 12-22 mJ/m², 12-20 mJ/m², or 12-18 mJ/m².

A layer (e.g., an oleophobic and/or a hydrophobic layer) can comprise a plurality of individual layers formed from the coating composition(s). Non-limiting examples of a layer comprising a plurality of individual layers of the present disclosure are described herein. In an example, one or more layer(s) (e.g., oleophobic and/or hydrophobic layer(s)) is/are disposed on a portion of, substantially all of, or all of one or more surface(s) of a substrate (e.g., external surface(s) or the like) or on a portion of, substantially all of, or all of one or more surface(s) of another layer. In various examples, a substrate and/or one or more layer(s) (e.g., oleophobic and/or hydrophobic layer(s)) disposed thereon is/are fluorine-free (e.g., substantially fluorine-free or completely fluorine-free).

In an example, a portion of, substantially all of, or all polymeric particle(s) in a layer are at least partially coalesced (e.g., fused or the like). In various example(s), a layer is crosslinked and/or comprises one or more crosslinked group(s) (e.g., within layer(s), between layer(s), and/or between layer(s) and a substrate). In various examples, crosslinked group(s) comprise one or more crosslinked pendant group(s) (e.g., crosslinked pendant polysiloxane group(s) such as, for example, crosslinked pendant PDMS group(s)).

In various examples, a substrate comprises one or more re-entrant structure(s). Non-limiting examples of re-entrant structure(s) include fibrous structure(s), T-shaped structure(s) and derivative structure(s), such as, for example, trapezoidal, matchstick-like, hoodoo-like/inverse opal, mushroom-like structures, or the like. In various examples, a substrate comprises two or more different (e.g., different in terms of one or more properties such as, for example, one or more dimension, one or more type of re-entrant structures, and the like) re-entrant structures. In various examples, the oleophobic behavior of a layer disposed on a substrate with these structure(s) is determined by the capillary length, the radius of the overhang R, the microstructure spacing D, and the local texture angle v, or the like, or a combination thereof. Compared with the fibrous structure, the T-shaped structure is expected to have increased oil repellency as it is expected to allow maximizing these parameters simultaneously. In an example, a substrate does not include any re-entrant structure(s).

In an aspect, the present disclosure provides methods of making layers. In various examples, the layers are oleophobic and/or hydrophobic layers. In various examples, the methods are based on coating of aqueous dispersions comprising polymeric particles. In various examples, a method produces a layer (e.g., an oleophobic an/or hydrophobic layer) of the present disclosure. Non-limiting examples of methods of making layers (e.g., oleophobic and/or hydrophobic layers) are described herein.

In various examples, a method comprises forming a layer (e.g., a molecularly rough layer) (e.g., an oleophobic and/or hydrophobic layer). In various examples, a layer is an oleophobic and/or hydrophobic layer. In various examples, a layer is disposed on a portion of, substantially all of, or all of one or more or all surface(s) (e.g., one or more or all exterior surface(s) or the like) of a substrate (e.g., a substrate as described herein such as, for example, a fabric, a fiber, a filament, glass, ceramic, carbon, metals or alloys, wood, polymer, plastic, paper, membrane, concrete, brick, leather, rubber, or the like). In various examples, a method of forming a layer (e.g., an oleophobic and/or hydrophobic layer) comprises providing a substrate.

In various examples, a method comprises coating (e.g., by dip or spray coating or the like) a portion of, substantially all of, or all of one or more surface(s) (e.g., one or more or all exterior surface(s) or the like) of a substrate with an aqueous dispersion (which may be a coating composition (e.g., an oleophobic and/or hydrophobic coating composition). In various examples, a coating composition is environmentally friendly and/or biocompatible. In various examples, a coating composition is water based and/or comprises low volatility organic compounds. In various examples, a coating composition is fluorine free.

In various examples, an aqueous dispersion comprises a plurality of polymeric particles (e.g., polymeric microparticles, polymeric nanoparticles, or the like, or any combination thereof) (e.g., oleophobic and/or hydrophobic polymeric particles). Non-limiting examples of polymeric particles are described herein.

In various examples, polymeric particles comprise one or more polymer(s) and/or one or more copolymer(s) (e.g., random copolymer(s), block copolymer(s), or the like, and any combination thereof). In various examples, polymer(s) is/are oleophobic and/or hydrophobic polymer(s) and/or copolymer(s) is/are oleophobic and/or hydrophobic copolymer(s). In various examples, at least a portion of, substantially all of, or all polymeric particles are composite polymeric particles (e.g., composite polymer microparticles, composite polymer nanoparticles, or the like, or any combination thereof), where each composite polymeric particle comprises a core-shell structure, the core comprising one or more nanoparticle(s) (e.g., unmodified nanoparticle(s), modified nanoparticle(s), or any combination thereof) (e.g., silica nanoparticle(s) or the like); and the shell comprising one or more or all polymer(s) and/or one or more or all copolymer(s).

Polymeric particles can comprise various particle sizes and particle size distributions thereof. Non-limiting examples of particle sizes of polymeric particles are described herein. In various examples, the polymeric particle(s) is/are polymeric microparticle(s), polymeric nanoparticle(s), or the like, or any combination thereof. In various examples, the polymeric particle(s), independently, has/have a size of from about 3 nm to about 1000 microns (e.g., from about 10 nm to about 1000 nm, from about 50 nm to about 500 nm, or from about 100 nm to about 300 nm), including all 0.1 nm values and ranges therebetween. In various examples, at least a portion of, substantially all, or all polymeric particles have a particle size a size of from about 3 nm to about 1000 microns (e.g., from about 10 nm to about 1000 nm, from about 50 nm to about 500 nm, or from about 100 nm to about 300 nm), including all 0.1 nm values and ranges therebetween.

Polymeric particles can comprise various numbers and types of surface charges. Non-limiting examples of surface charges are described herein. In various examples, individual polymeric particle(s) carry one or more surface charge(s) chosen from one or more positive charge(s), one or more negative charge(s), one or more zwitterionic charge(s), and any combination thereof. In various examples, the surface charge(s) is/are pH dependent.

Polymer(s) and/or copolymer(s) can comprise various molecular weights (M_{w} and/or Mₙ). The molecular weights (M_{w} and/or Mₙ) of polymer(s) and/or copolymer(s) can be measured using gel permeation chromatography or the like. Non-limiting examples of molecular weights (M_{w} and/or Mₙ) are described herein. In various examples, polymer(s) and/or copolymer(s) comprise(s) a molecular weight (M_{w} and/or Mₙ) of from about 300 g/mol to about 1,000,000 g/mol, including all integer g/mol values and ranges therebetween. In various examples, polymer(s) and/or copolymer(s), independently, has/have from about 3 repeat units to about 50,000 repeat units, including all integer values and ranges therebetween.

In various examples, a polymer or a copolymer comprises a backbone. Non-limiting examples of backbones are described herein. In various examples, the polymer(s) and/or the copolymer(s) comprise(s) one or more oleophobic and/or hydrophobic backbone(s). In various examples, polymer backbone(s) and/or copolymer backbone(s) is/are independently at each occurrence chosen from polydimethylsiloxane backbone(s), hydrocarbon polymer backbone(s) (e.g., polyethylene backbone(s), polypropylene backbone(s), polybutene backbone(s), and the like), poly(vinyl chloride) backbone(s), polytetrafluoroethylene backbone(s), polyacrylate backbone(s), polymethacrylate backbone(s), polyarylene backbone(s) (e.g., poly(styrene) backbone(s) and the like), polyether backbone(s), poly(vinyl ester) backbone(s), poly(allyl ether) backbone(s), polyester backbone(s), polyurethane backbone(s), polyurea backbone(s), polyamide backbone(s), polyimide backbone(s), polysulfone backbone(s), polycarbonate backbone(s), copolymer(s) thereof. In various examples, polymer backbone(s) and/or copolymer backbone(s) is/are independently at each occurrence linear or branched backbone(s). In various examples, polymer(s) comprise one or more same or different polymer backbone(s) and/or segment(s) thereof and/or copolymer(s) comprise one or more same or different copolymer backbone(s) and/or segment(s) thereof.

Polymer(s) and/or copolymer(s) can comprise various types of substituent groups. As used herein, unless otherwise indicated, a substituent group replaces a hydrogen atom on a polymer or copolymer backbone. Substituent group(s) include, but are not limited to, pendant group(s), which extend (e.g., form a side chain) from a polymer or copolymer backbone. Non-limiting examples of substituent group(s) are described herein. In various examples, substituent group(s) comprise(s) oleophobic and/or hydrophobic group(s) or the like. In various examples, substituent group(s) comprise crosslinkable group(s) or the like. In various examples, substituent group(s) comprise oleophobic and/or hydrophobic group(s) or the like and crosslinkable group(s) or the like.

In various examples, at least one or more or all polymer(s) and/or at least one or more or all copolymer(s) comprise(s) one or more pendant group(s) (e.g., oleophobic and/or hydrophobic pendant group(s) (e.g., crosslinkable pendant group(s)). In various examples, pendant group(s) comprise(s) the following structure:

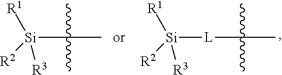

where R¹, R², and R³ are independently at each occurrence chosen from alkyl groups, alkoxy groups, aryl groups, hydroxyl groups, halogen groups, substituted derivates and analogs thereof, and —O—SiR′₃ groups, where R′ is independently at each occurrence chosen from alkyl groups, aryl groups, and substituted derivates and analogs thereof, and where L is a linking group. In various examples alkyl groups, alkoxy groups, and the like comprise C₁-C₄ alkyl groups, such as, for example, a methyl group, and the like. In various examples, for at least one or more of the pendant group(s) of each of the polymer(s) and/or each of the copolymer(s), at least one of R¹, R², and R³ is independently at each occurrence chosen from the —O—SiR′₃ groups, In various examples, pendant group(s) is/are independently at each occurrence covalently bonded, directly or via an L linking group, to the polymer(s) and/or the copolymer(s) (e.g., via backbone(s) and/or substituent group(s) of the polymer(s) and/or the copolymer(s)).

In various examples, in addition to any present linking group (L), pendant group(s) comprise(s) alkylsilane group(s) (e.g., mono-, bis-, and tris-alkylsilane group(s), and the like, and any combination thereof), alkylsiloxysilyl group(s) (e.g., mono-, bis-, and tris-(trialkylsiloxy) silyl group(s) and the like, and any combination thereof), alkoxysilane group(s) (e.g., mono-, di-, or tri-alkoxysilane group(s), and the like, and any combination thereof), or the like, or any combination thereof. In various examples, the alkyl and/or alkoxy group(s) independently at each occurrence comprise(s) C₁ to C₄₀ alkyl group(s) (e.g., trimethylsilane group(s), tris(trimethylsiloxy)silyl group(s), trimethoxysilane group(s), and the like, and any combination thereof). In various examples, in addition to any present L linking group, polymer(s) and/or copolymer(s) comprise(s) pendant group(s) comprising pendant (alkylsiloxy)silyl group(s) and, optionally, pendant alkoxysilane group(s) (referred to herein as polysiloxane resin(s) comprising one or more pendant polysiloxane group(s) (also referred to herein as PDMS resin(s) comprising PDMS group(s)). In various examples, pendant polysiloxane group(s) comprise linear polysiloxane group(s), branched polysiloxane group(s), or any combination thereof.

In various examples, pendant group(s) comprise(s) a molar ratio of alkylsiloxysilyl group(s) (e.g., mono-, bis-, and tris-(trialkylsiloxy)silyl group(s) (e.g., tris(trimethylsiloxy)silyl group(s) and the like) and the like, and any combination thereof) or the like, to alkoxysilane group(s) (e.g., mono-, di-, and tri-alkoxysilane group(s) (e.g., trimethoxysilane group(s) and the like), or the like, or any combination thereof) or the like, of about 1 or greater.

In various examples, pendant group(s), independently, comprise(s) a following structure:

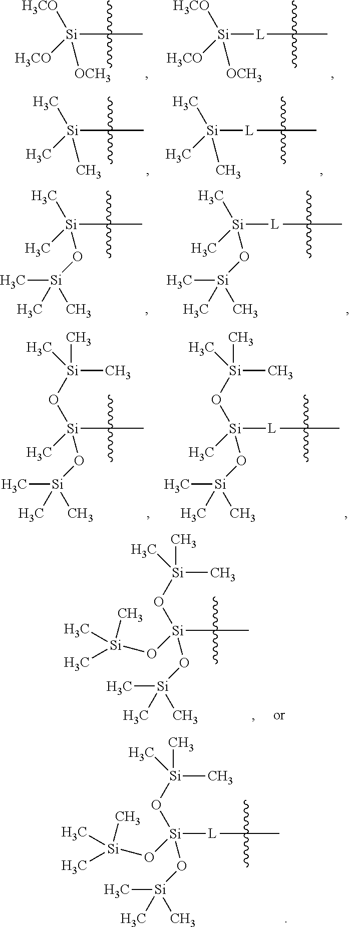

In various examples, one or more or all polymer(s) and/or one or more or all copolymer(s) do(es) not comprise(s) a pendant group on a terminal position of the polymer(s) and/or the copolymer(s).

Pendant group(s) can comprise various linking groups (L). Non-limiting examples of linking groups are described herein. In various examples, a linking group (L) is independently at each occurrence an —O— group, a —CH₂— group, a —(CH₂)₂— group, a —(CH₂)₃— group, a —OSi(CH₃)₂O— group, a —OSi(CH₂CH₃)₂O— group, a —CH₂O— group, a —CH₂CH₂O— group, a —CH₂C═O— group, a —OC═ONH— group, a —CH₂N— group, a —CH₂SO₂— group, a

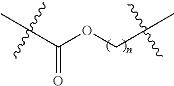

group, a

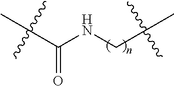

group, or a

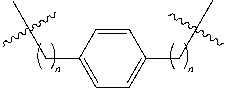

group, where n is 0-40, including all integer n values and ranges therebetween.

In various examples, from about 10% (e.g., mol %) to about 100% (e.g., mol %) (e.g., from about 40% (e.g., mol %) to about 100% (e.g., mol %), greater than 50% (e.g., mol %), or from about 50% (e.g., mol %) to about 100% (e.g., mol %)), including all 0.1% (e.g., mol %) values and ranges therebetween, of the repeat units of backbone(s) of polymer(s) and/or copolymer(s) comprise(s) pendant group(s). In various examples, from about 10% (e.g., mol %) to about 100% (e.g., mol %) (e.g., from about 40% (e.g., mol %) to about 100% (e.g., mol %), greater than 50% (e.g., mol %), or from about 50% (e.g., mol %) to about 100% (e.g., mol %)), including all 0.1% (e.g., mol %) values and ranges therebetween, of the repeat units of backbone(s) of polymer(s) and/or copolymer(s) comprise(s) tris(trialkylsiloxy)silyl functional pendant group(s).

In various examples, at least one or more or all polymer(s) and/or at least one or more or all copolymers comprise(s) one or more crosslinkable group(s). In various examples, crosslinkable group(s) is/are crosslinkable backbone group(s), crosslinkable substituent group(s) (e.g., crosslinkable pendant group(s) or the like), or the like, or any combination thereof. In various examples, crosslinkable group(s) is/are chosen from acrylate group(s), methacrylate group(s), allyl group(s), vinyl group(s), thiol group(s), hydroxyl group(s), alkoxysilyl group(s), silanol group(s), carboxylic acid group(s), aldehyde group(s), amine group(s), isocyanate group(s), azide group(s), alkyne group(s), epoxy group(s), halide group(s), hydrogen group(s), and the like, and combinations thereof.

In various examples, a method comprises, prior to the coating, forming an aqueous dispersion comprising a plurality of polymeric particles. In various examples, forming an aqueous dispersion comprises: forming a reaction mixture comprising: one or more monomer(s) comprising the pendant group(s) of the present disclosure, where the pendant group(s) may be first pendant group(s); optionally, one or more comonomer(s); one or more surfactant(s); optionally, one or more initiator(s); optionally, one or more crosslinker(s) (e.g., each comprising two or more crosslinkable groups (e.g., crosslinkable groups of the present disclosure)); optionally, a plurality of particles (e.g. (e.g., silica nanoparticles, modified silica nanoparticles, or the like); optionally, one or more non-aqueous solvent(s); and water; and holding the reaction mixture for a time and/or at a temperature such that the aqueous dispersion comprising a plurality of polymeric particles is formed. Non-limiting examples of methods of forming an aqueous dispersion comprising a plurality of polymeric particles are disclosed herein.

In various examples, a method comprises, prior to forming an reaction mixture, forming one or more modified silica nanoparticle(s), the method further comprising: treating one or more silica nanoparticle(s) with one or more monomer(s), each comprising an alkoxysilane group (e.g., 3-(trimethoxysilyl) propyl methacrylate and the like), where the modified silica nanoparticle(s) is/are formed. In various examples, at least a portion of, substantially all of, or all formed polymeric particles are composite polymeric particles (e.g., composite microparticles, composite nanoparticles, or the like, or any combination thereof), where each composite polymeric particle comprises a core-shell structure, the core comprising one or more nanoparticle(s) (e.g., unmodified nanoparticle(s), modified nanoparticle(s), or any combination thereof) (e.g., silica nanoparticle(s) or the like) and the shell comprising one or more or all polymer(s) and/or one or more or all copolymer(s).

A reaction mixture can comprise various monomer(s). In various examples, individual monomer(s) is/are chosen from backbone monomer(s) (as used herein, unless otherwise indicated, backbone monomer(s) is/are capable of polymerizing to form polymer backbone(s) and/or copolymer backbone(s) (e.g., the polymer backbone(s) and/or copolymer backbone(s) of the present disclosure)). In various examples, individual monomer(s) comprise(s) one or more of the pendant group(s) of the present disclosure.

In various examples, monomer(s) comprise(s) alkylsilane group(s) (e.g., mono-, di-, or tri-alkylsilane group(s)), (alkylsiloxy)silyl group(s) (e.g., mono-, bis-, or tris-(trialkylsiloxy) silyl groups(s), or the like, or any combination thereof), alkoxysilane groups(s) (mono-, di-, or tri-alkoxysilane group(s), or the like, or any combination thereof) or the like, or any combination thereof. In various examples, monomer(s) is/are vinyl monomer(s) (e.g., alkylacrylate monomer(s), alkylmethacrylate monomer(s), and the like, and any combination thereof) and the like. In various examples, the alkyl and/or alkoxy group(s) of monomer(s) is/are independently at each occurrence chosen from C₁ to C₄₀ alkyl groups. Non-limiting examples of monomer(s) include trimethyl silyl propyl acrylate, tris(trimethylsiloxy)silyl propyl acrylate, trimethoxysilane propyl methacrylate, and the like.

In various examples, monomer(s) comprise(s) one or more crosslinkable monomer(s) (e.g., monomer(s) comprising one or more crosslinkable group(s)). In various examples, crosslinkable monomer(s) comprise monomer(s) comprising one or more alkoxysilane group(s) (mono-, di-, or tri-alkoxysilane group(s), or the like, or any combination thereof, such as, for example, trimethoxysilane propyl methacrylate and the like).

In various examples, a reaction mixture comprises a molar ratio of alkylsiloxysilyl monomer(s) (e.g., monomer(s) comprising one or more alkylsiloxysilyl group(s) (e.g., mono-, bis-, or tris-(trialkylsiloxy)silyl group(s) (e.g., tris(trimethylsiloxy)silyl propyl acrylate and the like)) and the like, and any combination thereof) or the like, to alkoxysilane monomer(s) (e.g., monomer(s) comprising one or more alkoxysilane group(s) 5 (e.g., mono-, di-, or tri-alkoxysilane group(s) (e.g., trimethoxysilane propyl methacrylate and the like)) and the like, and any combination thereof) or the like, of about 1 or greater. In various examples, a reaction mixture comprises from about 10 molar percent (mol %) to about 100 mol % (e.g., from about 40 molar percent (mol %) to about 100 mol %), including all 0.1 mol % values and ranges therebetween, of monomer(s), based on total moles of monomer(s) and comonomer(s). In various examples, a reaction mixture comprises from about 10 molar percent (mol %) to about 100 mol % (e.g., from about 40 molar percent (mol %) to about 100 mol %), including all 0.1 mol % values and ranges therebetween, of monomer(s) comprising tris(trimethylsiloxy)silyl group(s) and the like, based on total moles of monomer(s) and comonomer(s).

A reaction mixture can comprise various components other than monomer(s). In various examples, a reaction mixture comprises one or more comonomer(s). In various examples, monomer(s) and comonomer(s) is/are chosen from the same or different backbone monomer(s). In various examples, comonomer(s) do not comprise(s) pendant group(s) (e.g., pendant group(s) of the present disclosure).

In various examples, a reaction mixture comprises one or more surfactant(s). In various examples, the hydrophile-lipophile balance (HLB) value of the surfactant(s) ranges from 7 to 20 (e.g., from about 9 to about 14), including all 0.1 HLB values and ranges therebetween. In various examples, surfactants(s) is/are chosen from anionic surfactant(s), cationic surfactant(s), zwitterionic surfactant(s), nonionic surfactant(s), and any combination thereof. In various examples, a portion of, substantially all of, or all surfactant(s) is/are chosen from fluorine free surfactant(s). Non-limiting examples of suitable surfactant(s) include hexadecyltrimethylammonium bromide, sodium dioctyl sulfosuccinate, polyoxyethylene oleyl ether, and polyoxyethylene nonylphenol. In various examples, the reaction mixture comprises from about 0.01 weight percent (wt. %) to about 40 wt. % (e.g. from about 0.01 wt. % to about 10 wt. % or from about 0.6 wt. % to about 2 wt. %), including all 0.01 wt. % values and ranges therebetween, of surfactant(s).

In various examples, a portion of, substantially all of, or all comonomer(s) and/or surfactant(s) comprise(s) one or more ionically charged functional group(s), where the ionically charged functional group(s) independently at each occurrence comprise(s) one or more positive charge(s), one or more negative charge(s), or one or more zwitterionic charge(s). In various examples, charge(s) of functional group(s) is/are pH dependent.

In various examples, surface charge(s) of polymeric particles is/are controlled by comonomer(s) and surfactant(s). In various examples, a positively charged coating is prepared using comonomer(s) and/or surfactant(s) containing positively charged functionalities (which may be pH dependent positively charged functionalities) including, but not limited to, amines, pyridines, imidazoles, guanidines, sulfonium cations, ammonium cations, phosphonium cations, bromonium cations, and the like, and any combination thereof. In various examples, a negatively charged coating is prepared using comonomer(s) and/or surfactant(s) containing negatively charged functionalities (which may be pH dependent negatively charged functionalities) including, but not limited to, sulfonates, sulfates, phosphates, carboxylates, sulfonic acids, sulfuric acids, phosphorus oxoacids, carboxylic acids, and the like, and any combination thereof. In various examples, a neutral coating is achieved using comonomer(s) and/or surfactant(s) with neutral groups (which may be pH dependent neutral functionalities) including, but not limited to, hydroxyl groups, ethers, amines, and the like, and any combination thereof. In various examples, a neutral coating is achieved using any neutral zwitterionic comonomers and/or surfactants containing both a positively charged cationic functional group including, but not limited to, amines, pyridines, imidazoles, guanidines, sulfonium, ammonium, phosphonium, bromonium cations, and the like, and any combination thereof, and a negatively charged functional group including, but not limited to, sulfonates, phosphates, and carboxylate groups.

A reaction mixture can comprise one or more initiator(s). In various examples, initiator(s) is/are chosen from thermal initiator(s), photoinitiator(s), redox initiator(s), reversible-deactivation radical initiator(s), anionic initiator(s), cationic initiator(s), Ziegler-Natta catalysts, and the like, and any combination thereof. In various examples, initiator(s) is/are chosen from water soluble initiators, oil soluble initiators, interfacial redox initiators and the like, and any combination thereof. In various examples, initiator(s) exhibit a 10-hour half-life temperature of from about 20° C. to about 80° C. (e.g., from 40° C. to 70° C.), including all 0.1° C. values and ranges therebetween. Non-limiting examples of water-soluble initiators include ammonium persulfate, potassium persulfate, 2,2′-azobis(2-methylpropionamidine) dihydrochloride, t-butyl hydroperoxide/ascorbic acid, and the like, and any combination thereof. Non-limiting examples of oil soluble initiators include 2,2′-azobis(isobutyronitrile), 2,2′-azobis(2,4-dimethylvaleronitrile), lauroyl peroxide, and the like, and any combination thereof. Non-limiting examples of interfacial redox initiators include cumene hydroperoxide/tetraethylenepentamine, dodecylamine/potassium persulfate, and the like, and any combination thereof. In various examples, a reaction mixture comprises from about 0.01 weight percent (wt. %) to about 20 wt. % (e.g., from about 0.01 wt. % to about 5 wt. %), including all 0.01 wt. % values and ranges therebetween, of initiator(s). Various methods can be used for initiation in the place of or in addition to initiator(s). In various examples, initiation is induced by heat, ionizing radiation, sonication (e.g., ultrasonication), electrochemical methods (such as, for example, using an electrochemical electrode or the like), or the like, or any combination thereof.

Various polymerization methods can be used to form an aqueous dispersion. In various examples, a polymerization method comprises an emulsion polymerization, a miniemulsion polymerization, a microemulsion polymerization, a dispersion polymerization, an interfacial polymerization, or a suspension polymerization. In various examples, a method further comprises post-polymerization functionalizing of polymer(s) and/or copolymer(s) to form one or more pendant group(s) (e.g., pendant group(s) of the present disclosure), where the pendant group(s) is/are second pendant group(s). In various examples, the polymerization method is an emulsion polymerization. In various examples, the polymeric particles are latex polymer particles. In various examples, an aqueous dispersion is not a polymer solution.

Various coating methods can be used. Examples of coating methods include, but are not limited to, spray coating, dip coating, flow coating, floating knife coating, roll coating (such as, for example, direct roll coating or the like), padding, calendar coating, foam coating, spin coating, or the like, and any combination thereof.

A method can coat various substrates. A substrate can be of various sizes and shapes. A substrate can have various compositions. A substrate can be porous or nonporous. Examples of substrate materials include, but are not limited to, fabrics, fibers, filaments, glasses, ceramics, carbons, metals and metal alloys, woods, polymers, plastics, papers, membranes, concrete, bricks, leather, rubber, and the like. In various examples, the substrate is fluorine-free. In various examples, a coated substrate (e.g., tactile properties, physical properties, or the like, or a combination thereof) has substantially the same or same properties as the uncoated substrate.

A substrate can be a fabric. In various examples, a fabric comprises a plurality of fibers. In various examples a fabric is naturally or modified to be superhydrophilic, hydrophilic, hydrophobic, or superhydrophobic. A fabric can be a cotton, PET (polyethylene terephthalate), blend (e.g., cotton/PET blends or the like), nylon, polyester, spandex, silk, wool, viscose, cellulose fiber (e.g., TENCEL® or the like), acrylic, polypropylene, or blends thereof. The fabric can be leather. A fabric can have a woven (e.g., plain, twill, satin weave, or the like), knitted (e.g. single jersey, double jersey, pique, mesh, or the like), or non-woven (e.g., felts, fibrous matts, membrane, film, leather, paper, or the like) structure. In various examples, a substrate is a fabric and a layer is disposed on the exterior of the fabric. In various examples, a substrate is a fabric and a layer is disposed in at least a portion of, substantially all, or all of the interstitial spaces of the fabric (e.g., formed by the fibers of a fabric). In various examples, a substrate is a fabric and a layer is disposed on the exterior of the fabric and in at least a portion of, substantially all, or all of the interstitial spaces of the fabric (e.g., formed by the fibers of a fabric).

In various examples, where the substrate is a fabric comprising a plurality of fibers, at least a portion of, substantially all of, or all of the polymeric particles disposed on the fabric comprise at least one or all dimension(s) that is/are about the same size as and/or a smaller size, e.g., on average or the like, than one or more dimension(s) of the fibers. In various examples, the dimension(s) is/are dimension(s) perpendicular to a longest axis of the fibers, cross-sectional dimension(s), or the like, or any combination thereof.

A layer can be disposed on a fabric that has a hydrophilic layer and/or a superhydrophilic layer disposed on a portion of, substantially all of, or all exterior surface(s) of a fabric. Non-limiting examples of superhydrophilic layers can be found in U.S. patent application Ser. No. 14/122,535 (Wang et al. “Antifouling Ultrafiltration and RO/FO Membranes”), the disclosure with respect to superhydrophilic layers and methods of making superhydrophilic layers therein is incorporated herein by reference. In an example, a hydrophilic layer and/or a superhydrophilic layer is/are disposed on opposite sides of a fabric from a layer of the present disclosure (e.g., an oleophobic and/or hydrophobic layer).

In various examples, a hydrophilic layer and/or a superhydrophilic layer comprises a plurality of hydrophilic nanoparticles and/or superhydrophilic nanoparticles. In various examples, the hydrophilic nanoparticles and/or superhydrophilic nanoparticles is/are silica nanoparticles that are surface functionalized with alkyl siloxane linker groups. In various examples, a hydrophilic layer has a surface that has a contact angle of less than 30 degrees, less than 25 degrees, less than 20 degrees, or less than 15 degrees. In various examples, a superhydrophilic layer has a surface that has a contact angle of less than 10 degrees, or less than 5 degrees. Hydrophilic layers and/or superhydrophilic layers can be formed from nanoparticles made by methods known in the art. In various examples, a contact angle of a hydrophilic layer and/or a superhydrophilic layer is determined using water as a test liquid according to a method as disclosed herein.

In various examples, a method comprises pretreating a substrate prior to coating. In various examples, pretreating a substrate comprises performing a chemical treatment (e.g., plasma treatment, solvent cleaning, oxidization treatment, hydrolysis treatment, or the like, and combinations thereof), a physical treatment (e.g. sanding treatment or the like), a primer treatment (e.g., with a primer, such as, for example, a sol comprising one or more sol-gel precursor(s) and epoxide primer(s), comprising one or more acrylate group(s), methacrylate group(s), allyl group(s), vinyl group(s), thiol group(s), hydroxyl group(s), silanol group(s), carboxylic acid group(s), carboxylate group(s), aldehyde group(s), amine group(s), isocyanate group(s), azide group(s), epoxy group(s), halide groups(s), hydrogen group(s), and the like, and combinations thereof), or a combination thereof.

In various examples, a primer treatment forms one or more primer layer(s)) on a portion of, substantially all of, or all of one or more exterior surface(s) (e.g., all exterior surface(s)) of the substrate. In various examples, primer layer(s) comprise(s) one or more functional group(s) which increase(s) the crosslinking density between the substrate and the oleophobic and/or hydrophobic layer. In various examples, primer layer(s) comprise(s) a sol of one or more non-metal oxide(s) (e.g., silicon oxides and the like), a sol of one or more metal oxide(s) (e.g., aluminum oxides, titanium oxides, iron oxides, copper oxides, and the like, and combinations thereof), or any combination thereof. In various examples, a substrate comprises a plurality of nanoparticles disposed in or upon the primer layer(s). In various examples, a primer coated substrate, such as, for example, a silica sol-coated substrate or the like, comprises one or more functional group(s) chosen from acrylate group(s), methacrylate group(s), allyl group(s), vinyl group(s), thiol group(s), hydroxyl group(s), silanol group(s), carboxylic acid group(s), carboxylate group(s), aldehyde group(s), amine group(s), isocyanate group(s), azide group(s), alkyne group(s), epoxy group(s), halide group(s), hydrogen group(s), and combinations thereof, which increase the crosslinking density between coated substrate and the oleophobic and/or hydrophobic layer.

In an example, pretreating the substrate comprises depositing and/or growing nanoparticles, or the like on a portion of, substantially all of, or all of one or more exterior surface(s) (e.g., all of the exterior surface(s)) of a substrate. In various examples, a method comprises forming a layer comprising a plurality of nanoparticles on a portion of, substantially all of, or all of one or more exterior surface(s) (e.g., all of the exterior surface(s)) of a fabric prior to formation of an oleophobic and/or hydrophobic layer of the present disclosure. In various examples, pretreating the substrate comprises coating (e.g., by dip coating or spray coating or the like) a portion of, substantially all of, or all of one or more exterior surface(s) of a fabric with a silica sol (e.g., a silica sol formed by hydrolyzing one or more tetraalkoxysilane(s) (e.g., in an alcohol/water solution) (e.g., under alkaline conditions) or the like and drying the coated fabric. In various examples, a combination of tetraalkoxysilanes is used. Examples of tetraalkoxysilane(s) include, but are not limited to, tetramethoxysilane, tetraethoxysilane, tetrapropyl orthosilicate, tetrabutyl orthosilicate, and combinations thereof. In various examples, a silica sol is formed by acidifying sodium silicate. In various examples, pretreating the substrate further comprises contacting the dried fabric with silica nanoparticles and the like (e.g., a suspension of silica nanoparticles or the like).

In various examples, a substrate is cleaned prior to use. In an example, a substrate (e.g., a fabric or fabric having a plurality of nanoparticles disposed thereon) is cleaned (e.g., plasma cleaned, oxidized, rinsed with solvents (such as, for example, water and/or other solvents, such as, for example, organic solvents or the like), or the like) prior to pretreating a substrate (e.g., coating a substrate with a primer coating (e.g., a silica sol coating) or prior to coating a substrate with an aqueous dispersion comprising a plurality of polymeric particles of the present disclosure.

In various examples, a layer comprises a plurality of nanoparticles (e.g., unmodified nanoparticles or modified nanoparticles) (e.g., silica nanoparticles, modified silica nanoparticles, or the like, or any combination thereof). In various examples, a plurality of nanoparticles is added to a reaction mixture when an aqueous dispersion of polymeric particles is formed. In various examples, a plurality of nanoparticles is added to an aqueous dispersion of polymeric particles prior to coating a substrate with the aqueous dispersion. In various examples, an oleophobic and/or hydrophobic layer comprises from about 0.1 weight percent (wt. %) to about 98 wt. % (e.g., 1-95 wt. % or 1-50 wt. % or 20-40 wt. %), including all 0.01 wt. % values and ranges therebetween, of the plurality of nanoparticles (e.g., silica nanoparticles, modified silica nanoparticles, or the like, or any combination thereof).

In various examples, a plurality of nanoparticles comprise multifunctional nanoparticles. As used herein, unless otherwise indicated, “multifunctional nanoparticles” means that more than one type of functional groups are immobilized on the nanoparticles, e.g., the silanol groups on nanoparticles or the like. Without intending to be bound by any particular theory, it is considered that the multifunctional nanoparticles improve the compatibility with the polymer(s) and/or copolymer(s) and/or the pendant group(s) to reduce the surface energy. In various examples, the nanoparticles (e.g., silica nanoparticles or the like) and/or polymer(s) and/or copolymer(s) and/or substrate have covalent and/or hydrogen bonds with surface functional groups of the nanoparticles (e.g., between nanoparticles and other nanoparticles, polymer(s), copolymer(s), and/or a substrate).

Various nanoparticles can be used. In various examples, the nanoparticles are metal, carbon, metal oxide, or semi-metal oxide (e.g., silica) nanoparticles, or the like, or any combination thereof. The nanoparticles can be surface functionalized with low surface energy groups (e.g., trimethylsiloxy, methyl, t-butyl, benzoxazine, PDMS groups, or the like). The nanoparticles can have various morphologies. In various examples, the nanoparticles are spherical, nanoplates, nanotubes, nanorods, nanowires, hierarchical structures generated by such nanoparticles, or the like, or any combination thereof. In an example, a layer comprises a plurality of silica nanoparticles (e.g., Ludox HS silica, or other commercially available colloidal silica particles). The nanoparticles can be present in various amounts. In various examples, the nanoparticles are present in a layer at 0-95 wt. %, including all integer number wt % values and ranges there between, based on the total weight of the layer. In an example, the nanoparticles are present in a layer at 20-40 wt %. The interaction between the silica nanoparticles and resin or fabric/fiber can be in the form of covalent and/or hydrogen bonds involving surface functional groups of the nanoparticles.

In various examples, an aqueous dispersion comprises a mixture of polymeric particles (e.g., polymeric microparticles, polymeric nanoparticles, or the like, and any combination thereof) (e.g., at least one or more or all polymeric particle(s) is/are composite polymeric particle(s)) (e.g., at least two or more or all polymeric particles comprise one or more different compositional and/or structural feature(s) from other polymeric particles) and optionally nanoparticles (e.g., unmodified nanoparticles or modified nanoparticles) (e.g., silica nanoparticles or the like) (e.g. at least two or more or all nanoparticles comprise one or more different compositional and/or structural feature(s) from other nanoparticles). In various examples, a substrate is coated with aqueous dispersion comprising the mixture of polymeric particles and optionally nanoparticles. Without intending to be bound by any particular theory, it is considered that the mixture of polymeric particles and optionally nanoparticles increase the surface roughness of the layer. In various examples, the mixture of polymeric particles and/or particles increases mechanical durability and strength of a layer (e.g., a fabric or the like with a layer disposed on a least a portion of, substantially all of, or all of one or more surface(s) (e.g., one or more or all exterior surface(s)) of the fabric) or the like.

In various examples, the method further comprises curing (e.g., thermally curing or the like) the oleophobic and/or hydrophobic layer. In various examples, curing coalesces at least a portion of the polymeric particles and/or crosslinks at least a portion of any crosslinking groups, if present. In various examples, the curing comprises maintaining the coating at a temperature of from about −30 degrees Celsius (° C.) to about 200° C., including all 0.1° C. values and ranges therebetween, for a time of from about 1 second to about 2 weeks, including all 1 second values and ranges therebetween. In various examples, the curing comprises heating the coating (e.g., heating to a temperature of about room temperature (e.g., from about 20° C. to about 22° C., including all 0.1° C. values and ranges therebetween, or the like) or greater. In various examples, the coating is cured by heating to a temperature of from about 25° C. to about 190° C. (e.g., from about 110° C. to about 160° C.), including all 0.1° C. values and ranges therebetween. In various examples, the curing partially or completely coalesces a portion of, substantially all of, or all polymeric particles and/or composite nanoparticles in the layer.

In various examples, during the curing, at least a portion of, substantially all of, or all crosslinking group(s), if present in the oleophobic and/or hydrophobic layer, react to form one or more crosslinked group(s). In various examples, crosslinking occurs between one or more polymer(s) and/or one or more copolymer(s) of the layer (e.g., intermolecular crosslinking and/or intramolecular crosslinking) (e.g., between one or more crosslinkable group(s) of polymer(s) and/or one or more crosslinkable group(s) of copolymer(s) (e.g., crosslinkable backbone group(s) and/or crosslinkable substituent group(s) (e.g., crosslinkable pendant group(s)))). In various examples, crosslinking occurs between a substrate (e.g. between one or more functional group(s) of a substrate, one or more functional group(s) of a coating disposed on a substrate, or the like, or any combination thereof) and one or more polymer(s) and/or copolymer(s) of the layer (e.g., between one or more crosslinkable group(s) of polymer(s) and/or one or more crosslinkable group(s) of copolymer(s) (e.g., crosslinkable backbone group(s) and/or crosslinkable substituent group(s) (e.g., crosslinkable pendant group(s)))).

In various examples, crosslinking forms a crosslinked group from reaction of or between crosslinkable group(s) of polymer(s) and/or copolymer(s) (e.g., crosslinkable backbone group(s) and/or crosslinkable substituent group(s) (e.g., crosslinkable pendant group(s)) and/or a substrate (e.g., functional group(s) of a substrate, a coating disposed on a substrate, or the like, or any combination thereof)). In various examples, a crosslinked group comprises one or more —Si—O—Si— group(s) not present in the crosslinking group(s) reacted to form the crosslinked group. In various examples, a layer comprises at least one crosslink (e.g., more than two, more than 5, more than 10 crosslinks, or more than 25 crosslinks) of or between polymer(s) and/or copolymer(s) (e.g., at least one intramolecular crosslink and/or at least one intermolecular crosslink) and/or at least one crosslink (e.g., more than two, more than 5, more than 10 crosslinks, or more than 25 crosslinks) between a substrate and one or more polymer(s) and/or one or more copolymer(s).

In various examples, crosslinkable pendant group(s) form crosslinked pendant group(s) from reaction(s) of crosslinked pendant group(s) with other crosslinked pendant group(s) and/or with a substrate. In various examples, crosslinkable pendant alkoxysilane group(s) of polysiloxane resin(s) (e.g., PDMS resin(s) or the like) form crosslinked pendant polysiloxane group(s) (e.g., crosslinked pendant PDMS group(s) or the like) from reaction(s) of crosslinked pendant polysiloxane group(s) (e.g., PDMS group(s)) with other crosslinked pendant polysiloxane group(s) (e.g., PDMS group(s)) and/or with a substrate. The polysiloxane (e.g., PDMS) group(s), before and/or after crosslinking, may be linear polysiloxane (e.g., PDMS) group(s), branched polysiloxane (e.g., PDMS) group(s), or any combination thereof.

In various examples, coating and, optionally, curing is/are repeated a desired number of times. It may be desirable to repeat the coating and, optionally, the curing to provide a layer having a desired thickness. In various examples, the coating and, optionally, the curing is/are repeated from about 1 to about 100 times (e.g., from about 1 to about 50 times, from about 1 to about 20 times, or the like) including all integer number of repetitions therebetween).

In various examples, a method further comprises adding additional surface roughness to the oleophobic and/or hydrophobic layer. Various methods can be used to form and/or increase surface roughness. In various examples, surface roughness is formed by, for example, nanofabrication, electrospinning, forced spinning, extrusion, mechanical stamping, abrasion, etching, or the like, or a combination thereof. In various examples, a layer or layers is/are patterned. In various examples, patterning of a layer or layers is accomplished by exploiting techniques developed for microcontact printing and soft lithography.

A layer can comprise various thickness values. In various examples, the thickness of the oleophobic and/or hydrophobic layer is from about 2 nm to about 1000 microns, including all 1 nm values and ranges therebetween. In various other examples, the thickness of a layer or layers is from about 10 nm to about 300 microns, from about 50 nm to about 100 microns, or the like, including all 1 nm values and ranges therebetween. In various examples, the maximum combined thickness of all layers is about 1000 microns.

In an aspect, the present disclosure provides uses of the layers of the present disclosure. An article of manufacture can comprise one or more layer(s) of the present disclosure. Non-limiting examples of uses of articles of manufacture of the present disclosure are described herein.

An article of manufacture can comprise one or more layer(s) of the present disclosure and/or one or more layer(s) made by a method of the present disclosure. Articles of manufacture can be used in various industries. Examples of industries include, but are not limited to, aerospace, automotive, building and construction, food processing, electronics, and the like.

Examples of articles of manufacture include, but are not limited to, textiles, clothing (e.g., clothing, such as, for example, children's clothing, adult clothing, industrial work clothing, and the like) such as, for example, shirts, jackets, pants, hats, ties, coats, shoes, and the like, food packaging, eye glasses, displays (e.g., touch screens), scanners (e.g., finger print scanners), sporting goods (e.g., tents, uniforms, and the like), building materials (e.g., windows), windshields, furniture, condensers, containers, toilets, lights, and the like.

A coating can comprise one or more layer(s) of the present disclosure. In various examples, a coating is an airplane coating (such as, for example, an anti-icing coating or the like), corrosion resistant coating, or the like.

The steps of the methods described in the various embodiments and examples disclosed herein are sufficient to carry out the methods of the present disclosure. Thus, in various examples, a method consists essentially of a combination of the steps of the methods disclosed herein. In various other examples, a method consists of such steps.

The following Statements describe various examples of methods, products and systems of the present disclosure and are not intended to be in any way limiting:
Statement 1. A layer (e.g., a molecularly rough layer) according to the present disclosure having a surface tension of less than or equal to 22 mJ/m² (e.g., 12-22 mJ/m²) disposed on a portion or all of an exterior surface (e.g., all of the exterior surfaces) of a substrate.
Statement 2. A layer (e.g., a layer disposed on at least a portion of a surface of a substrate) comprising one or more polymer(s), each polymer comprising: one or more polymer backbone(s) chosen from poly(dimethylsiloxane) s, hydrocarbon polymers (such as, for example, polyethylenes, polypropylenes, polybutenes, and the like), poly(vinyl chloride) s, polytetrafluoroethylenes, polyacrylates, poly(methacrylate) s, polyarylene(s) (such as, for example, poly(styrene) s and the like), poly(vinylester) s, poly(allylether) s, polyesters, polyurethanes, polyureas, polyamides, polyimides, polysulfones, polycarbonates, linear and branched analogs thereof, and copolymers thereof, and combinations thereof, and at least one pendant group having the following structure:

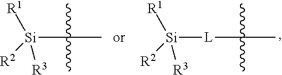

where R¹, R², and R³ are independently at each occurrence chosen from alkyl groups, aryl groups, and —O—SiR′₃ groups, where R′ groups independently chosen from alkyl groups (e.g., C₁-C₄ alkyl groups, such as, for example, methyl group), aryl groups, substituted derivates thereof, and the like, L is a linking group, e.g. a linking group comprising an alkyl group, an aryl group, a silyl group, or the like, and combinations thereof (e.g. a —CH₂— group, a —CH₂CH₂— group, a —CH₂CH₂CH₂— group, a

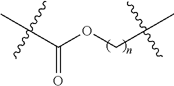

group, a

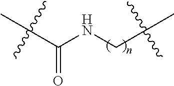

group, a

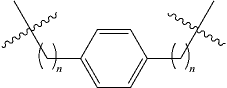

group, a —Si(CH₃)₂O—, a —CH₂O— group, a —CH₂CH₃O— group, a —CH₂C═O— group, a —OC═ONH— group, a —CH₂N— group, a —CH₂SO₂— group, or the like, where n is 0-40, including all integer n values and ranges therebetween, and where the layer is disposed on a portion of or all of an exterior surface of a substrate.
Statement 3. A layer according to Statement 1 or Statement 2, where the pendant group(s) is/are, independently at each occurrence, chosen from:

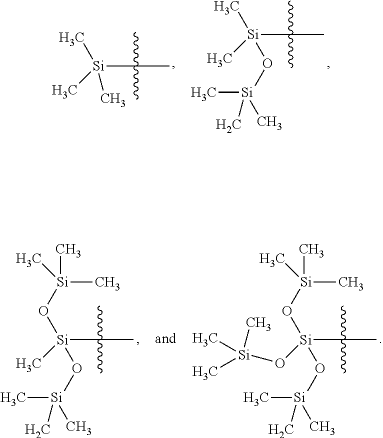

Statement 4. A layer according to Statement 3, where one or more or all of the pendant group(s) is/are covalently bonded to a polymer backbone by a linking group.
Statement 5. A layer according to any one of Statements 2-4, where at least one of the one or more polymer(s) and/or copolymer(s) comprises one or more crosslinkable group(s).
Statement 6. A layer according to Statement 5, where the crosslinkable groups are selected from acrylate, methacrylate, allyl, vinyl, thiol, hydroxyl, silanol, carboxylic acid, aldehyde, amine, isocyanate, azide, alkyne, epoxy, halide, hydrogen, or the like, or combinations thereof.
Statement 7. A layer according to any one of the preceding Statements, where the layer further comprises at least one crosslink (e.g., more than two, more than 5, more than 10 crosslinks, or more than 25 crosslinks), which may be intramolecular and/or intermolecular crosslink(s) and/or at least one crosslink (e.g., more than two, more than 5, more than 10 crosslinks, or more than 25 crosslinks) between one or more polymer(s) and/or one or more copolymer(s) and the substrate.
Statement 8. A layer according to any one of Statements 2-7, where the pendant PDMS (which may be a branched pendant PDMS is formed by polymerization of one or more tris(trialkylsiloxy)silyl vinyl compound(s) (e.g., tris(trialkylsiloxy)silyl alkylacrylates such as, for example, tris(trialkylsiloxy)silyl methacrylate, and the like) and trimethoxysilane vinyl compound (e.g., alkylacryloxyalkoxytrimethoxysilanes and the like), where the alkyl moieties (e.g., alkyl moiet(ies) and/or alkyl group(s)) are independently at each occurrence C₁ to C₄₀ alkyl moieties.
Statement 9. A layer according to any one of the preceding Statements, where the layer is cured.
Statement 10. A layer according to any one of the preceding Statements, where the layer comprises a plurality of nanoparticles disclosed herein (e.g., silica nanoparticles such as Ludox HS silica and other commercially available colloidal silica particles).
Statement 11. A layer according to Statement 10, where the plurality of nanoparticles is chosen from silica nanoparticles, or the like, or combinations thereof.
Statement 12. A layer according to any one of Statements 10 or 11, where the weight percentage of the nanoparticles is 1-98 wt % (e.g., 1-95 wt % or 1-50 wt %) based on the total weight of the layer.
Statement 13. A layer according to any one of Statements 10-12, where the weight percentage of the nanoparticles can be 0-95 wt %, preferably from 20-40 wt %.
Statement 14. A layer according to any one of the preceding Statements, where the substrate is a substrate disclosed herein.
Statement 15. A layer according to any one of the preceding Statements, where the thickness of the layer is 2 nm to 1000 microns (e.g., 50 nm to 100 microns and 10 nm to 300 microns), including all nm values and ranges therebetween.
Statement 16. A layer according to any one of the preceding Statements, where the substrate comprises (or is) a fabric, fiber, filament, glass, ceramic, carbon, metals, wood, polymer, plastic, paper, membrane, concrete, brick, or the like.
Statement 17. A layer according to Statement 16, where the fabric is comprises cotton, PET, cotton/PET blends, nylon, polyester, spandex, silk, wool, viscose, cellulose fiber, acrylic, polypropylene, blends thereof (e.g., a blend of two or more yarns, which may form a fabric, comprising cotton, PET, cotton/PET blends, nylon, polyester, spandex, silk, wool, viscose, cellulose fiber, acrylic, polypropylene yarns as a fabric material), leather, or a combinations thereof.
Statement 18. A layer according to Statement 17, where the substrate is a fabric comprising a superhydrophilic layer disposed on a portion of an exterior surface of the fabric.
Statement 19. A layer according to any one of c Statements 2-18, where the layer exhibits a surface tension of less than or equal to 22 mJ/m².
Statement 20. A layer according to Statement 19, where the layer having a surface tension of less than or equal to 22 mJ/m² and the superhydrophilic layer are disposed on opposite sides of a fabric.
Statement 21. A layer according to any one of the preceding Statements, where the substrate and/or layer is fluorine-free.
Statement 22. A layer according to any one of the preceding Statements, where the layer passes AATCC® Test Method 118-2013 for one or more oil(s) (e.g., one or more oil(s) set out in AATCC® Test Method 118-2013, such as, for example, an oil (e.g., corn oil, vegetable oil, mineral oil (grade 1 defined in AATCC® Test Method 118-2013), or the like) and/or exhibit an oil (e.g., oil grade 1) contact angle greater than 90° and/or exhibit an oil (e.g., oil grade 3) contact angle greater than 70°. The AATCC® Test Method 118-2013 or contact angle measurement may be carried out using a flat, non-porous substrate.
Statement 23. A method of forming a layer (e.g., a molecularly rough layer) of the present disclosure (e.g., a layer having a surface tension of less than 22 mJ/m²) disposed on a portion or all of an exterior surface (e.g., a portion or all of the exterior surfaces) of a substrate (e.g., a fabric) comprising: optionally, providing the substrate (e.g., the fabric); coating (e.g., by spray coating, dip coating, flow coating, floating knife coating, roll coating (such as, for example, direct roll coating or the like), padding, calendar coating, foam coating, or the like) a portion or all of an exterior surface (e.g., a portion or all of the exterior surfaces) of the substrate with an aqueous emulsion comprising nanoparticles comprising one or more polymer(s) (the nanoparticles may be referred to as polymerized latex particles); and optionally, curing (e.g., thermally curing) the coating formed from the aqueous emulsion, where the layer (e.g., a molecularly rough layer) of the present disclosure (e.g., a layer having a surface tension of less than 22 mJ/m²) is formed on a portion or all of an exterior surface (e.g., a portion or all of the exterior surfaces) of the substrate.
Statement 24. A method according to Statement 23, further comprising forming the aqueous emulsion comprising nanoparticles, the forming comprising: forming a reaction mixture comprising: one or more monomer(s), one or more or all which may be pendant group monomer(s); optionally, one or more comonomer(s); one or more surfactant(s); optionally, one or more initiator(s); and water; and holding the reaction mixture at a time and temperature such that the aqueous emulsion comprising nanoparticles is formed.
Statement 25. A method according to Statement 23 or Statement 24, the method further comprising post-polymerization functionalizing the polymer(s) with one or more pendant group(s).
Statement 26. A method according to any one of Statements 23-25, where the substrate is a fabric, fiber, filament, glass, ceramic, carbon, metals, wood, polymer, plastic, paper, membrane, concrete, brick, or the like.
Statement 27. A method according to any one of Statements 23-26, where the substrate is a fabric has a superhydrophilic layer disposed on all or at least a portion of an exterior surface of the fabric (e.g., the side of the fabric opposite of the side on which the layer of the present disclosure (e.g., layer having a surface tension of less than or equal to 22 mJ/m²) is formed).
Statement 28. A method according to any one of Statements 23-27, where the substrate is fluorine-free.
Statement 29. A method according to any one of Statements 23-28, where the forming comprises coating (e.g., by dip coating or spray coating) a portion or all of an exterior surface of the substrate with a silica sol (e.g., a silica sol formed by hydrolyzing one or more tetraalkoxysilane(s) (e.g., in an alcohol/water solution) (e.g., under alkaline conditions) and drying the coated fabric.
Statement 30. A method according to Statement 29, where the coating is spray coating, dip coating, floating knife coating, direct roll coating, padding, calendar coating, foam coating, or a combination thereof.
Statement 31. A method according to Statement 29 or Statement 30, further comprising contacting the dried substrate with nanoparticles (e.g., silica nanoparticles, such as, for example, a suspension of silica nanoparticles).
Statement 32. A method according to any one of Statement 29-31, further comprising pretreatment of the substrate.
Statement 33. A method according to any one of Statements 29-32, comprising forming a layer on all or a portion or all of an exterior surface (e.g., all of the exterior surfaces) of the substrate prior to formation of the layer of the present disclosure (e.g., layer having a surface tension of less than 22 mJ/m²).
Statement 34. A method according to any one of Statements 29-33, where the pretreatment is a chemical treatment (e.g., plasma treatment, solvent cleaning, oxidization treatment, hydrolysis treatment, or the like, and combinations thereof), a physical treatment (e.g. sanding treatment or the like), a primer treatment (e.g., with a primer, such as, for example, a sol comprising one or more sol-gel precursor(s) and epoxide primer(s), comprising one or more acrylate group(s), methacrylate group(s), allyl group(s), vinyl group(s), thiol group(s), hydroxyl group(s), silanol group(s), carboxylic acid group(s), carboxylate group(s), aldehyde group(s), amine group(s), isocyanate group(s), azide group(s), epoxy group(s), halide groups(s), hydrogen group(s), or the like, or combinations thereof), or a combination thereof.
Statement 35. A method according to any one of Statements 29-34, where the pretreatment comprises coating a portion of or all of an exterior surface of the substrate with a non-metal oxide (e.g., silicon oxides and the like), a metal oxide (e.g., aluminum oxides, titanium oxides, iron oxides, copper oxides, and the like, and combinations thereof), or a combination thereof (e.g., a layer comprising non-metal oxide, a metal oxide, or a combination thereof) sol. For example, a coated substrate, such as, for example, a silica sol-coated substrate, comprises one or more functional group(s) such, for example, acrylate groups, methacrylate groups, allyl groups, vinyl groups, thiol groups, hydroxyl groups, silanol groups, carboxylic acid groups, carboxylate groups, aldehyde groups, amine groups, isocyanate groups, azide groups, alkyne groups, epoxy groups, halide groups, hydrogen groups, and combinations thereof, which may increase the crosslinking density between coated substrate and the layer.
Statement 36. A method according to any one of Statements 29-35, where the substrate is cleaned (e.g., plasma cleaned) prior to coating with the silica sol.
Statement 37. A method according to any one of Statements 23-36, where the substrate has a plurality of nanoparticles disposed thereon.
Statement 38. A method according to any one of Statements 23-37, further comprising contacting the substrate (e.g., which may comprise a dried and/or cured layer) with nanoparticles. A portion of or all of the nanoparticles (e.g., silica nanoparticles or the like) may be covalently linked to the substrate, bonded and/or aggregated with other nanoparticles, or a combination thereof.
Statement 39. A method of any one of Statements 23-38, where the coating and curing (e.g., the coating and curing of any of claims 8-16) are repeated a desired (e.g., 1-20) number of times.
Statement 40. A method according to any one of Statements 23-39, further comprising adding additional surface roughness to the layer (e.g., by nanofabrication, electrospinning, forced spinning, extrusion, mechanical stamping, abrasion, etching, or a combination thereof).
Statement 41. An article of manufacture comprising one or more layer(s) of the present disclosure. For example, one or more layer(s) of any one of Statements 1-22 and/or one or more layer(s) formed by a method of any one of Statements 23-40.
Statement 42. An article of manufacture comprising one or more fabric(s) comprising a layer (e.g., a molecularly rough layer) of the present disclosure (e.g., a layer having a surface tension of less than 22 mJ/m²) disposed on a portion or all of an exterior surface (e.g., all of the exterior surfaces) of a substrate disclosed herein (e.g., a layer of any one of the Statements 1-23 or a layer made by a method of any one of Statements 23-40).
Statement 43. An article of manufacture of any one of Statements 41 or 42, where the article of manufacture is an article described herein.
Statement 44. An article of manufacture of any one of Statements 41-43, where the article of manufacture is a textile, an article of clothing, food packaging, eye glasses, a display, a scanner, an airplane coating, a sporting good, a building material, a window, a windshield, a corrosion resistant coating, an anti-ice coating, or a cooler (e.g., a condenser for cooling vapors such as for example, water vapors), a light (e.g., a traffic light, a headlight, a lamp, or the like).

The following examples are presented to illustrate the present disclosure. They are not intended to be limiting in any matter.

### Example 1

This example provides a description of an aqueous dispersion of the present disclosure. This example also describes characterization of the aqueous dispersion.

Synthesis of a positively charged waterborne dispersion of polymeric particles (which may also be referred to herein as a cationic latex). In a typical synthesis, a cationic emulsion was prepared by homogenizing 3-[tris(trimethylsiloxy)silyl]propyl acrylate (24 g), 3-(trimethoxysilyl) propyl methacrylate (0.8 g), hexadecyltrimethylammonium bromide (0.2 g), 2,2′-azobis(2,4-dimethylvaleronitrile) (0.2 g), and water (56 g) at room temperature. After purging with nitrogen for 10 minutes, the cationic emulsion was quickly heated to 57° C. and maintained at that temperature for 3 hours. The average size of the polymerized cationic latex particles is ˜180 nm with a zeta potential of ˜+34 mv and can be tuned by changing the amount of cationic surfactant.

### Example 2

This example provides a description of an aqueous dispersion of the present disclosure. This example also describes characterization of the aqueous dispersion.

Synthesis of a negatively charged waterborne dispersion of polymeric particles (which may also be referred to herein as an anionic latex). In a typical synthesis, an anionic emulsion was prepared by homogenizing 3-[tris(trimethylsiloxy)silyl]propyl acrylate (24 g), 3-(trimethoxysilyl) propyl methacrylate (0.8 g), Calfax 16 L-35 (0.3 g), 2,2′-azobis(2,4-dimethylvaleronitrile) (0.2 g), and water (56 g) at room temperature. After purging with nitrogen for 10 minutes, the anionic emulsion was quickly heated to 57° C. and maintained at that temperature for 3 hours. The average size of the anionic latex particles formed is ˜230 nm with a zeta potential of ˜−36 mv and can be tuned by changing the amount of anionic surfactant.

### Example 3

This example provides a description of an aqueous dispersion of the present disclosure. This example also describes characterization of the aqueous dispersion.

Synthesis of a neutral waterborne dispersion of polymeric particles (which may also be referred to herein as a nonionic latex) . . . . In a typical synthesis, a nonionic emulsion was prepared by homogenizing 3-[tris(trimethylsiloxy)silyl]propyl acrylate (24 g), 3-(trimethoxysilyl) propyl methacrylate (0.8 g), triton x-165 (0.4 g), 2,2′-azobis(2,4-dimethylvaleronitrile) (0.2 g), and water (56 g) at room temperature. After purging with nitrogen for 10 minutes, the nonionic emulsion was quickly heated to 57° C. and maintained at that temperature for 4 hours. The average size of the nonionic latex particles formed is ˜ 280 nm and can be tuned by changing the amount of nonionic surfactant.

### Example 4

This example provides a description of films of the present disclosure. This example also describes characterization of the films.

In a typical coating process, a piece of pristine fabric (e.g., a 5-inch by 5-inch square piece of cotton fabric) was dip coated with a waterborne fluorine-free oleophobic dispersion (e.g., of a cationic latex of Example 1). In a typical dip coating process, a 5-inch by 5-inch square of pristine fabric was dipped into 5 mL of the waterborne fluorine-free oleophobic dispersion (2 wt %) for 1 min and dried via padding at 0.1 MP. The coated fabric was then transferred to an oven preheated at 130° C. and cured for 30 seconds(s).

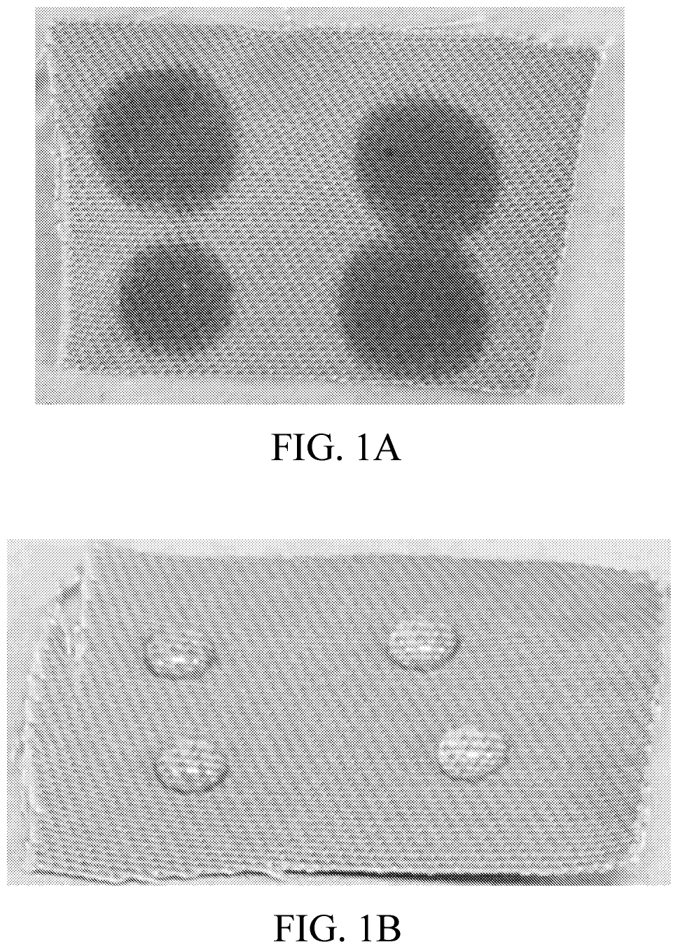

Fabric specimens with and without dip coating using a cationic waterborne fluorine-free oleophobic dispersion (of a cationic latex of Example 1) were tested using the Hydrocarbon Resistance Test (AATCC 118 protocol) for Oil Repellency. The pristine cotton fabric (FIG. 1A) was quickly penetrated by the mineral oil (oil grade 1, as determined by AATCC 118) while a cotton fabric (FIG. 1B) coated with the cationic waterborne fluorine-free oleophobic dispersion (of a cationic latex of Example 1) exhibited good oil repellency to mineral oil lasting several hours.

Coatings of the waterborne fluorine-free oleophobic dispersions (e.g., of the latexes of Examples 1-3) can be applicable to different types of fabrics and other substrates, e.g. paper, wood, leather and glass. Contact angles were taken using a goniometer that takes and analyzes the image of a sessile oil droplet on the substrate.

The contact angles of the cotton fabric samples coated with the cationic waterborne fluorine-free oleophobic dispersion (of a cationic latex of Example 1) against a test liquid were measured at ambient temperature using a Biolin Scientific Optical Tensiometer with OneAttension software. In a typical contact angle measurement, a droplet of a test liquid, e.g. mineral oil, is placed on the sample and the image of the sessile drop at the points of intersection between the drop contour and the projection of the surface is used to calculate the contact angle by the software. The contact angle values can also be used to calculate the surface free energy of the coating surface using the Owens-Wendt model. (See, e.g., Owens, D. K.; Wendt, R. C., Estimation of the Surface Free Energy of Polymers. J. Appl. Polym. Sci. 1969, 13, 1741-1747). Wetting behavior of a surface is categorized into four types based on its water contact angle: (i) superhydrophilic (0°<θ<10°), (ii) hydrophilic (10°<θ<90°), (iii) hydrophobic (90°<θ<150°), and (iv) superhydrophobic (150°<θ<180°). (See, e.g., Das, S.; Kumar, S.; Samal, S. K.; Mohanty, S.; Nayak, S. K., A Review on Superhydrophobic Polymer Nanocoatings: Recent Development and Applications. Ind. Eng. Chem. Res. 2018, 57, 2727-2745). Contact angles of different fabrics coated with the cationic waterborne fluorine-free oleophobic dispersion (of a cationic latex of Example 1) are summarized in Table 1. Contact angles were measured after applying the test oils for 30 seconds.

TABLE 1

| | Contact angle | |
|---|---|---|
| Fabric samples | (degree) | Test oils |
| Cotton, vendor 1 | 110 ± 8 | corn oil |
| Polyester, vendor 2 | 118 ± 4 | corn oil |
| Cotton, vendor 1 | 103 ± 9 | mineral oil |
| Polyester, vendor 2 | 114 ± 6 | mineral oil |

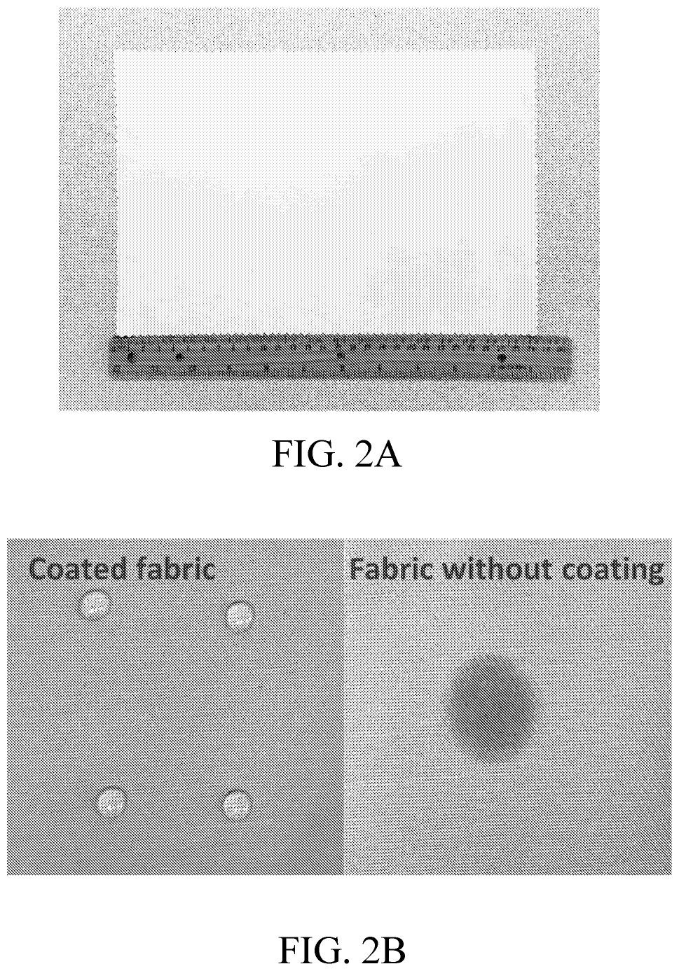

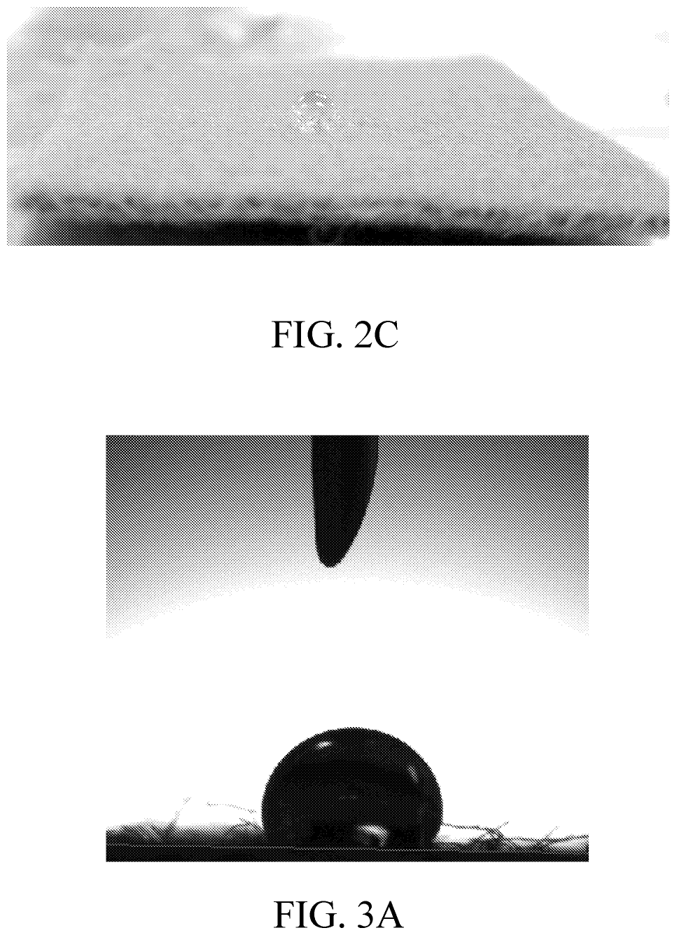

An additional representative cotton fabric coated with the cationic fluorine-free oleophobic dispersion (of a cationic latex of Example 1) is shown in FIG. 2A. An oil repellence comparison was performed between an additional representative cotton fabric coated with the cationic fluorine-free oleophobic dispersion (of a cationic latex of Example 1) (FIG. 2B, left) and a pristine fabric without any coating (FIG. 2B, right). The oil tested is a mineral oil (grade 1 oil according to AATCC-118). A further oil repellence test was performed using a vegetable oil for a wool fabric coated with the cationic fluorine-free oleophobic dispersion (of a cationic latex of Example 1) (FIG. 2C).

Table 2 shows contact angle measurements for a coating of the cationic fluorine-free oleophobic dispersion (of a cationic latex of Example 1) on treated cotton, wool, and polyester fabrics performed using the Biolin Scientific Optical Tensiometer with OneAttension software. The apparent contact angle was measured after applying the test oil droplet to the substrate for 30 seconds. The oil used for measuring contact angle of was a vegetable oil.

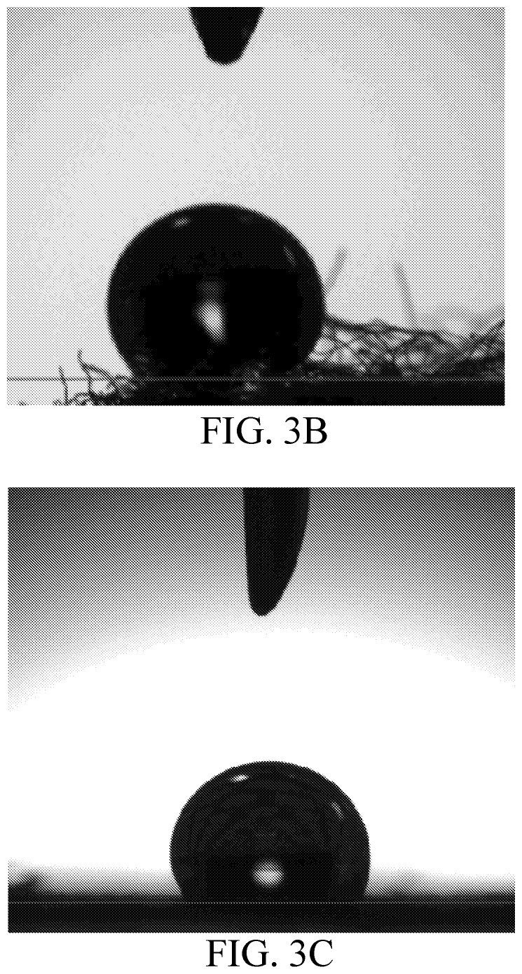

TABLE 2

| | Contact Angle | |
|---|---|---|
| Fabrics | (degree) | Sessile Drop |
| Cotton, vendor 3 | 121 | FIG. 3A |
| Wool, vendor 4 | 143 | FIG. 3B |
| Polyester, vendor 5 | 119 | FIG. 3C |

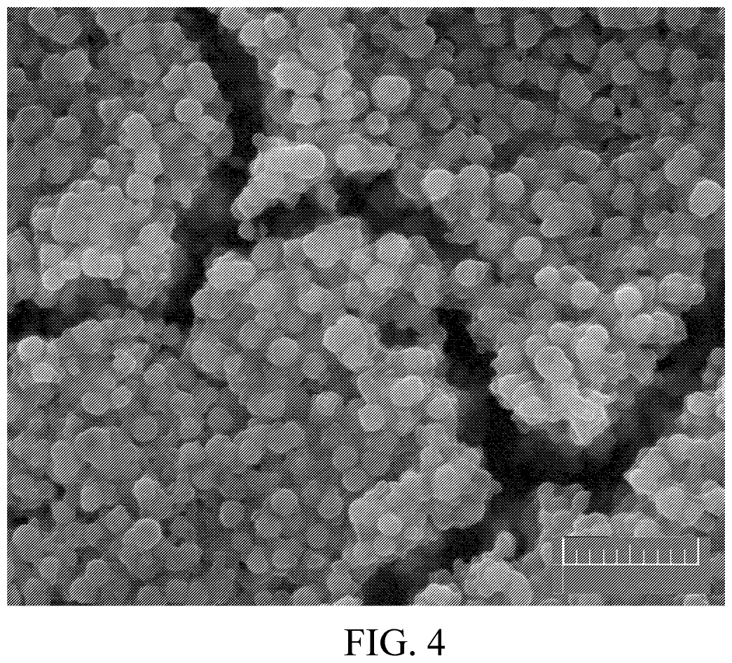

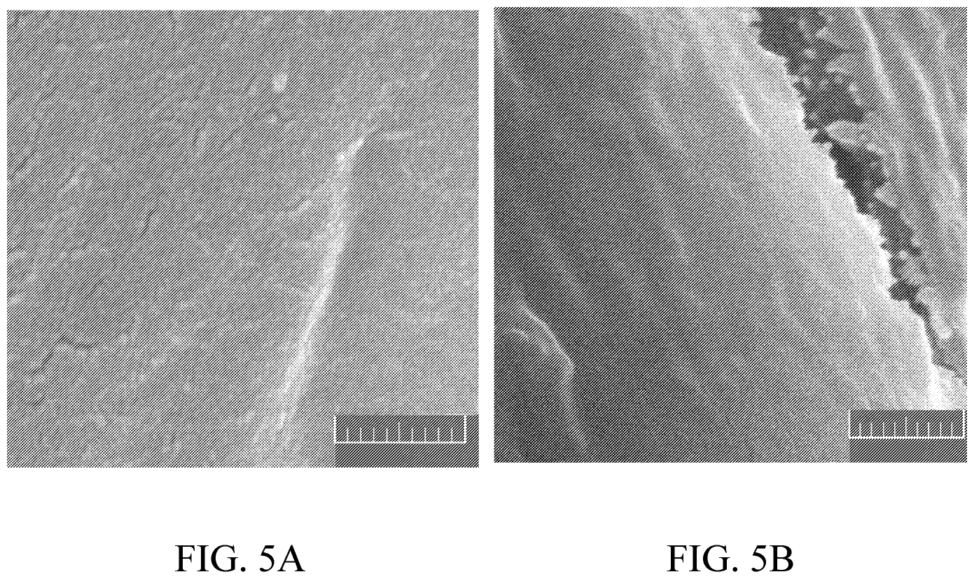

A scanning electron microscopy (SEM) image of a representative coating of the cationic fluorine-free oleophobic dispersion (of a cationic latex of Example 1) on a cotton substrate is shown in FIG. 4, scale bar=1 micron (μm) . . . . The latex nanoparticles have an average size of ˜180 nm. SEM images of (FIG. 5A) a pristine cotton fabric, scale bar=200 nm and (FIG. 5B) a cotton fabric coated with the cationic fluorine-free oleophobic dispersion (of a cationic latex of Example 1), scale bar=500 nm provide an estimated thickness of the fluorine-free oleophobic coating of less than 200 nm.

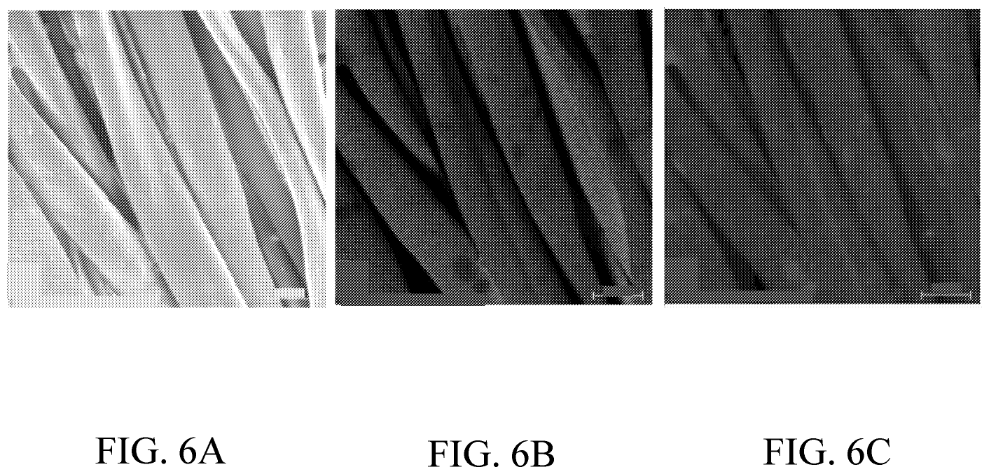

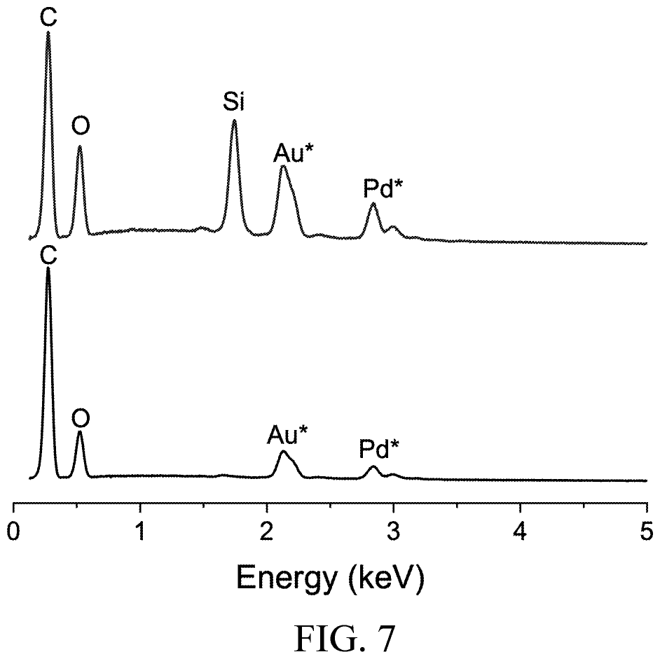

An SEM image of a representative cotton fabric coated with the cationic fluorine-free oleophobic dispersion (of a cationic latex of Example 1) is shown in FIG. 6A. Energy dispersive X-ray mapping for C (FIG. 6B) and Si (FIG. 6C), corresponding to the presence of the same coating as FIG. 6A, overlap well with FIG. 6A, suggesting that each fiber was covered by a relatively uniform layer of coating. An energy dispersive X-ray (EDX) spectrum of a pristine cotton fabric (bottom) and a cotton fabric sample coated with the cationic fluorine-free oleophobic dispersion (of a cationic latex of Example 1) (top) are shown in FIG. 7. No peak corresponding to fluorine was found in the energy dispersive X-ray (EDX) spectrum of the coated fabric sample (FIG. 7, top), confirming that the oleophobic coating is fluorine-free.

### Example 5

This example provides a description of an aqueous dispersion of polymeric composite particles of the present disclosure. This example also describes characterization of the aqueous dispersion of polymeric composite particles.

Synthesis of a positively charged waterborne dispersion of polymeric composite particles (which may also be referred to herein as a cationic composite latex). In a typical synthesis, a cationic emulsion was prepared by homogenizing 3-[tris(trimethylsiloxy)silyl]propyl acrylate (24 g), 3-(trimethoxysilyl) propyl methacrylate (0.8 g), hexadecyltrimethylammonium bromide (0.2 g), 2,2′-azobis(2,4-dimethylvaleronitrile) (0.2 g), 3-(trimethoxysilyl) propyl methacrylate modified silica nanoparticles (3 g, D50˜18 nm) and water (56 g) at room temperature. After purging with nitrogen for 10 minutes, the cationic emulsion was quickly heated to 57° C. and then maintained at that temperature for 3 hours. The average size of the cationic polymeric composite particles (which may also be referred to herein as cationic composite latex particles) is ˜200 nm with zeta potential of ˜+32 mv and can be tuned by changing the amount of cationic surfactant and the loading of silica nanoparticles.

The syntheses of negatively charged and neutral waterborne dispersions of polymeric composite particles (which may also be referred to herein as anionic and nonionic composite latexes, respectively) are similar to the synthesis of the cationic waterborne dispersion of polymeric composite particles except that suitable anionic and nonionic surfactants are used, respectively.

Synthesis of modified silica nanoparticles. In a typical synthesis, colloidal silica nanoparticles (1 g, 30 wt % in water, D50˜15 nm) were dispersed in 100 mL of ethanol and 3-(trimethoxysilyl) propyl methacrylate (1 g) was then added dropwise under stirring. The dispersion was heated to 75° C. and kept at that temperature overnight. The obtained modified silica nanoparticles were then dialyzed against ethanol and air dried.

The present disclosure has been shown and described with reference to specific examples, it should be understood by those having skill in the art that various changes in form and detail may be made therein without departing from the spirit and scope of the present disclosure as described herein.

1. A method of forming an oleophobic and/or hydrophobic layer disposed on a portion of, substantially all of, or all of one or more exterior surface(s) of a substrate, the method comprising:
coating a portion of, substantially all of, or all of one or more of the exterior surface(s) of the substrate with an aqueous dispersion comprising a plurality of polymeric particles, wherein each individual polymeric particle comprises one or more oleophobic and/or hydrophobic polymer(s) and/or one or more oleophobic and/or hydrophobic copolymer(s), wherein the polymer(s) and/or the copolymer(s) comprise(s) one or more pendant group(s) comprising the following structure: 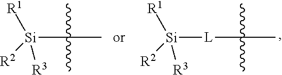
wherein R¹, R², and R³ are independently at each occurrence chosen from alkyl groups, alkoxy groups, aryl groups, hydroxyl groups, halogen groups, substituted derivatives and analogs thereof, and —O—SiR′₃ groups, wherein R′ is independently at each occurrence chosen from alkyl groups, aryl groups, and substituted derivates and analogs thereof, wherein, for at least one or more of the pendant group(s) of each of the polymer(s) and/or each of the copolymer(s), at least one of R¹, R², and R³ is independently at each occurrence chosen from the —O—SiR′₃ groups,
wherein L is a linking group, and
wherein the pendant group(s) is/are independently at each occurrence covalently bonded to the polymer(s) and/or the copolymer(s) via one or more backbone(s) and/or one or more substituent group(s) of the polymer(s) and/or the copolymer(s); and
wherein the oleophobic and/or hydrophobic layer is formed on a portion of, substantially all of, or all of one or more of the exterior surface(s) of the substrate; and
optionally, curing the oleophobic and/or hydrophobic layer.

2. The method of claim 1, wherein at least a portion of, substantially all of, or all of the polymeric particles are composite polymeric particles.

3. The method of claim 1, wherein the polymeric particle(s), independently, has/have a size of from about 3 nm to about 1000 microns.

4. The method of claim 1, wherein the backbone(s) is/are independently at each occurrence chosen from polydimethylsiloxane backbone(s), hydrocarbon polymer backbone(s), poly(vinyl chloride) backbone(s), polytetrafluoroethylene backbone(s), polyacrylate backbone(s), polymethacrylate backbone(s), polystyrene backbone(s), polyarylene backbone(s), polyether backbone(s), poly(vinyl ester) backbone(s), poly(allyl ether) backbone(s), polyester backbone(s), polyurethane backbone(s), polyurea backbone(s), polyamide backbone(s), polyimide backbone(s), polysulfone backbone(s), polycarbonate backbone(s), and copolymer(s) thereof.

5. The method of claim 1, wherein the pendant group(s) comprise(s) tris(trialkylsiloxy)silyl group(s), alkoxysilane group(s), or any combination thereof, and wherein the alkyl group(s) is/are independently at each occurrence chosen from C₁ to C₄₀ alkyl group(s).

6. The method of claim 1, wherein the pendant group(s), independently, comprise(s) the following structure:

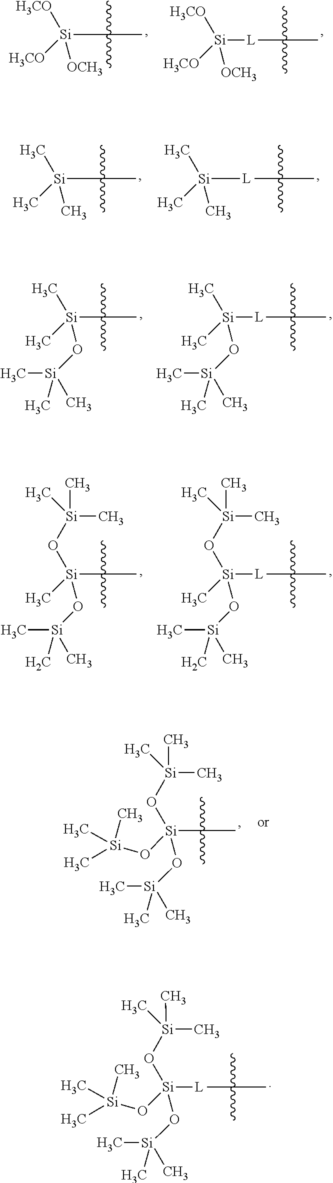

7. The method of claim 1, wherein the coating comprises spray coating, dip coating, floating knife coating, direct roll coating, padding, calendar coating, foam coating, spin coating, flow coating, or any combination thereof.

8. The method of claim 1, further comprising, prior to the coating, forming the aqueous dispersion comprising the plurality of polymeric particles, the forming comprising:
forming a reaction mixture comprising:
one or more monomer(s) comprising the pendant group(s), wherein the pendant group(s) is/are first pendant group(s);
optionally, one or more comonomer(s);
one or more surfactant(s);
optionally, one or more initiator(s);
optionally, one or more crosslinker(s);
optionally, a plurality of nanoparticles;
optionally, one or more non-aqueous solvent(s); and
water; and
holding the reaction mixture at a time and at a temperature such that the aqueous dispersion comprising the plurality of polymeric particles is formed.

9. The method of claim 8, wherein the monomer(s) comprise(s) tris(trialkylsiloxy)silyl vinyl monomer(s), alkoxysilane vinyl monomer(s), or any combination thereof, and wherein the alkyl group(s) is/are independently at each occurrence chosen from C₁ to C₄₀ alkyl group(s).

10. The method of claim 8, wherein the monomer(s) comprise(s) a molar ratio of the (trialkylsiloxy)silyl monomer(s) to the alkoxysilane monomer(s) of about 1 or greater.

11. The method of claim 8, wherein the reaction mixture comprises from about 40 molar percent (mol %) to about 100 mol % of the monomer(s) based on the total moles of the monomer(s) and the comonomer(s).

12. The method of claim 8 wherein the surfactant(s) is/are chosen from anionic surfactant(s), cationic surfactant(s), zwitterionic surfactant(s), nonionic surfactant(s), and any combination thereof.

13. The method of claim 8, wherein the reaction mixture comprises from about 0.01 weight percent (wt. %) to about 40 wt. % of the surfactant(s).

14. The method of claim 8, wherein the initiator(s) is/are chosen from thermal initiator(s), photoinitiator(s), redox initiator(s), reversible-deactivation radical initiator(s), anionic initiator(s), cationic initiator(s), Ziegler-Natta catalysts, and any combination thereof.

15. The method of claim 8, wherein the reaction mixture comprises from about 0.01 weight percent (wt. %) to about 20 wt. % of the initiator(s).

16. The method of claim 8, wherein the method comprises an emulsion polymerization, a miniemulsion polymerization, a microemulsion polymerization, a dispersion polymerization, an interfacial polymerization, or a suspension polymerization.

17. The method of claim 8, the method further comprising post-polymerization functionalizing the polymer(s) and/or the copolymer(s) to form one or more of the pendant group(s), wherein the pendant group(s) is/are second pendant group(s).

18. The method of claim 1, further comprising, prior to the coating, pretreating the substrate.

19. The method of claim 18, wherein the pretreating comprises coating the substrate with a primer layer comprising one or more functional group(s) which increase(s) the crosslinking density between the substrate and the oleophobic and/or hydrophobic layer.

20. The method of claim 19, wherein the primer layer comprises a sol of one or more non-metal oxide(s), a sol of one or more metal oxide(s), or any combination thereof.

21. The method of claim 19, wherein the substrate comprises a plurality of nanoparticles disposed in or upon the primer layer.

22. The method of claim 1, wherein the oleophobic and/or hydrophobic layer further comprises a plurality of nanoparticles.

23. The method of claim 1, wherein the curing comprises maintaining the coating at a temperature of from about −30 degrees Celsius (° C.) to about 200° C., and/or for a time of from about 1 second to about 2 weeks.

24. The method of claim 1, the method further comprising adding additional surface roughness to the oleophobic and/or hydrophobic layer.

25. The method of claim 1, wherein the coating and, optionally, the curing is/are repeated from 1 to 100 times.

26. The method of claim 1, wherein the thickness of the oleophobic and/or hydrophobic layer is from about 2 nm to about 1000 microns.

27. An oleophobic and/or hydrophobic layer, wherein the oleophobic and/or hydrophobic layer is disposed on a portion of, substantially all of, or all of one or more exterior surface(s) of a substrate, wherein the oleophobic and/or hydrophobic layer comprises a plurality of polymeric particles, wherein each individual polymeric particle comprises one or more oleophobic and/or hydrophobic polymer(s) and/or one or more oleophobic and/or hydrophobic copolymer(s), and wherein the polymer(s) and/or the copolymer(s) comprise(s) one or more pendant group(s) comprising the following structure: 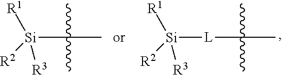
wherein R¹, R², and R³ are independently at each occurrence chosen from alkyl groups, alkoxy groups, aryl groups, hydroxyl groups, halogen groups, substituted derivatives and analogs thereof, and —O—SiR′₃ groups, wherein R′ is independently at each occurrence chosen from alkyl groups, aryl groups, and substituted derivates and analogs thereof, wherein, for at least one or more of the pendant group(s) of each of the polymer(s) and/or each of the copolymer(s), at least one of R¹, R², and R³ is independently at each occurrence chosen from the —O—SiR′₃ groups,
wherein L is a linking group, and
wherein the pendant group(s) is/are independently at each occurrence covalently bonded to the polymer(s) and/or the copolymer(s) via one or more backbone(s) and/or one or more substituent group(s) of the polymer(s) and/or the copolymer(s).

28. The layer of claim 27, wherein at least a portion of, substantially all of, or all of the polymeric particles are composite polymeric particles.

29. The layer of claim 27, wherein the polymeric particle(s), independently, has/have a size of from about 3 nm to about 1000 microns.

30. The layer of claim 27, wherein a portion of, substantially all of, or all of the polymeric particle(s) is/are at least partially coalesced.

31. The layer of claim 27, wherein the polymeric particle(s), independently, carr(ies) one or more surface charge(s) chosen from one or more positive charge(s), one or more negative charge(s), one or more zwitterionic charge(s), and any combination thereof.

32. The layer of claim 27, wherein the polymer(s) and/or the copolymer(s) comprise(s) a molecular weight (M_{w} and/or Mₙ) of from about 300 g/mol to about 1,000,000 g/mol, and/or wherein the polymer(s) and/or the copolymer(s), independently, has/have from about 3 repeat units to about 50,000 repeat units.

33. The layer of claim 27, wherein the backbone(s) is/are independently at each occurrence chosen from polydimethylsiloxane backbone(s), hydrocarbon polymer backbone(s), poly(vinyl chloride) backbone(s), polytetrafluoroethylene backbone(s), polyacrylate backbone(s), polymethacrylate backbone(s), polystyrene backbone(s), polyether backbone(s), polyarylene backbone(s), poly(vinyl ester) backbone(s), poly(allyl ether) backbone(s), polyester backbone(s), polyurethane backbone(s), polyurea backbone(s), polyamide backbone(s), polyimide backbone(s), polysulfone backbone(s), polycarbonate backbone(s), and copolymers thereof.

34. The layer of claim 27, wherein the pendant group(s) comprise(s) tris(trialkylsiloxy)silyl group(s), alkoxysilane group(s), or any combination thereof, and wherein the alkyl group(s) is/are independently at each occurrence chosen from C₁ to C₄₀ alkyl group(s).

35. The layer of claim 27, wherein the pendant group(s) comprise(s) a molar ratio of (trialkylsiloxy)silyl group(s) to alkoxysilane group(s) of about 1 or greater.

36. The layer of claim 27, wherein the pendant group(s), independently, comprise(s) the following structure:

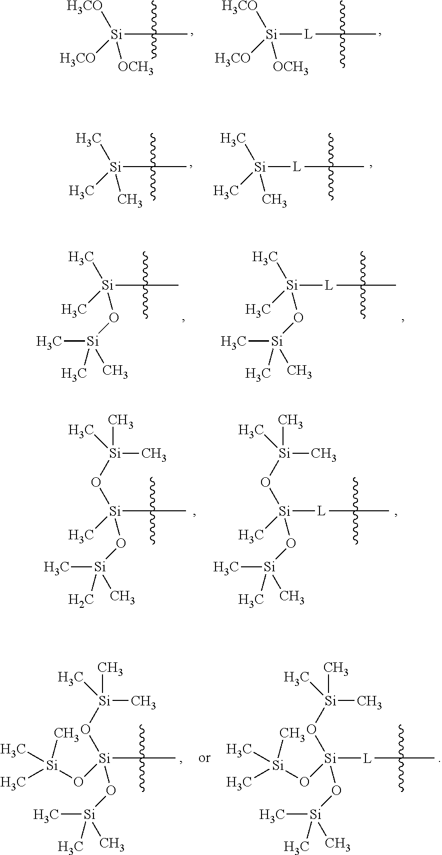

37. The layer of claim 27, wherein L is independently at each occurrence an —O— group, a —CH₂— group, a —(CH₂)₂— group, a —(CH₂)₃— group, a —OSi(CH₃)₂O— group, a —OSi(CH₂CH₃)₂O— group, a —CH₂O— group, a —CH₂CH₂O— group, a —CH₂C═O— group, a —OC—ONH— group, a —CH₂N— group, a —CH₂SO₂— group, a 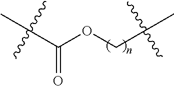
group, a 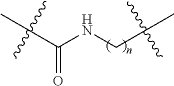
group, or a 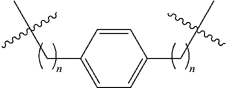
group, wherein n is 0-40.

38. The layer of claim 27, wherein from about 10% to about 100% of the repeat units of the backbone(s) comprise the pendant group(s).

39. The layer of claim 27, wherein the substrate is porous or nonporous.

40. The layer of claim 27, wherein the substrate is a fabric, a fiber, a filament, a membrane, glass, ceramic, carbon, metal or metal alloy, wood, polymer, plastic, paper, concrete, brick, leather, or rubber.

41. A layer according to claim 27, wherein the fabric comprises cotton, polyethylene terephthalate (PET), nylon, polyester, spandex, silk, wool, viscose, cellulose fiber, acrylic, polypropylene, leather, or any combination thereof.

42. The layer of claim 27, wherein the substrate is fluorine-free, and/or wherein the oleophobic and/or hydrophobic layer is fluorine-free.

43. The layer of claim 27, wherein the substrate comprises a plurality of nanoparticles.

44. The layer of claim 27, wherein the oleophobic and/or hydrophobic layer comprises a plurality of nanoparticles.

45. The layer of claim 44, wherein the oleophobic and/or hydrophobic layer comprises from about 0.1 weight percent (wt. %) to about 98 wt. % of the plurality of nanoparticles.

46. The layer of claim 27, wherein at least one of the polymer(s) and/or at least one of the copolymer(s) comprise(s) one or more crosslinkable group(s).

47. The layer of claim 27, wherein the oleophobic and/or hydrophobic layer comprises one or more crosslinked group(s).

48. The layer of claim 47, wherein the oleophobic and/or hydrophobic layer comprises one or more intramolecular and/or intermolecular crosslinked groups(s) and/or one or more crosslinked group(s) between the substrate and at least one of the polymer(s) and/or at least one of the copolymer(s).

49. The layer of claim 47, wherein the crosslinked group(s) comprise one or more crosslinked pending polysiloxane group(s), and wherein the polysiloxane group(s) is/are chosen from linear polysiloxane group(s), branched polysiloxane group(s), and any combination thereof.

50. The layer of claim 27, wherein the oleophobic and/or hydrophobic layer comprises additional surface roughness.

51. The layer of claim 27, wherein the oleophobic and/or hydrophobic layer comprises from 1 to 100 same or different oleophobic and/or hydrophobic layer(s).

52. The layer of claim 27, wherein the thickness of the oleophobic and/or hydrophobic layer is from about 2 nm to about 1000 microns.

53. The layer of claim 27, wherein the oleophobic and/or hydrophobic layer has a surface tension of 22 mJ/m² or less.

54. The layer of claim 27, wherein the oleophobic and/or hydrophobic layer comprises and/or exhibits one or more or all of the following:
a passing score for the AATCC® Test Method 118-2013 for one or more oil(s); or
a contact angle with an oil grade 1 of greater than 90°; or
a contact angle with an oil grade 3 of greater than 70°.

55. An article of manufacture comprising one or more oleophobic and/or hydrophobic layer(s) of claim 27.

56. The article of manufacture of claim 55, wherein the article of manufacture is a textile, an article of clothing, food packaging, eye glasses, a display, a scanner, an airplane coating, a sporting good, a building material, a window, a windshield, a corrosion resistant coating, an anti-ice coating, a condenser, a container, a toilet, or a light.

57. The article of manufacture of claim 55, wherein the substrate is a fabric.
